(19) United States
(12) Patent Application Publication
(10) Pub. No.: US 2023/0279165 A1
(43) Pub. Date: Sep. 7, 2023

(54) CURE AND FUNCTIONALIZATION OF OLEFIN/SILANE INTERPOLYMERS

(71) Applicants: Dow Global Technologies LLC, Midland, MI (US); Dow Silicones Corporation, Midland, MI (US)

(72) Inventors: Jordan C. Reddel, Midland, MI (US); Mark F. Sonnenschein, Midland, MI (US); David S. Laitar, Midland, MI (US); Andrew B. Shah, Collegeville, PA (US); Bethany M. Neilson, Manvel, TX (US); Colin LiPi Shan, Pearland, TX (US); David D. Devore, Midland, MI (US); Jozef J. I. Van Dun, Horgen (CH); Philip D. Hustad, St. Paul, MN (US); Zhanjie Li, Midland, MI (US); Zachary S. Kean, Bay city, MI (US); Ken Kawamoto, Midland, MI (US)

(73) Assignees: Dow Global Technologies LLC, Midland, MI (US); Dow Silicones Corporation, Midland, MI (US)

(21) Appl. No.: 18/013,224

(22) PCT Filed: Jun. 23, 2021
(86) PCT No.: PCT/US2021/038561

§ 371 Date: Dec. 27, 2022

Related U.S. Application Data
(60) Provisional application No. 63/043,204, filed on Jun. 24, 2020.

(51) Int. Cl. C08F 210/02

(52) U.S. Cl. CPC C08F 210/02; C08F 2420/02

(57) ABSTRACT

A process to form a crosslinked composition comprising thermally treating a composition at a temperature ≥ 25° C., in the presence of moisture, and wherein the composition comprises the following components: a) an olefin/silane interpolymer, b) a cure catalyst selected from the following: i) a metal alkoxide, ii) a metal carboxylate, iii) a metal sulfonate, iv) an aryl sulfonic acid, v) a tris-aryl borane, vi) any combination of two or more from i)-v). Also, a composition comprising the following components a and b, as described above. A process to form an olefin/alkoxysilane interpolymer, and the corresponding composition, said process comprising thermally treating a composition comprising the following components: a) an olefin/silane interpolymer, b) an alcohol, and c) a Lewis acid.

### CROSS-REFERENCE TO RELATED APPLICATIONS

The present application claims the benefit of priority to U.S. Provisional Application No. 63/043,204, filed on Jun. 24, 2020, which is incorporated herein by reference in its entirety.

### BACKGROUND OF THE INVENTION

Ethylene-based polymers can be crosslinked by a variety of methods. Such methods include, for example, peroxide, bis-azide, and reactive crosslinking of maleic anhydride functionality. All of these techniques typically require prior processing steps, for example, adding functionality to the polymer, before the polymer can be crosslinked.

U.S. Pat. 3,646,155 discloses the crosslinking of a polyolefin, by first reacting the polyolefin with an unsaturated, hydrolysable silane, at a temperature above 140° C., and in the presence of a compound capable of generating free radical sites in the polyolefin. The resultant polyolefin is subsequently exposed to moisture and a condensation catalyst (see abstract). U.S. Pat. 4,291,136 discloses a water-curable, silane modified alkylene alkylacrylate copolymer, produced by reacting an alkylene alkylacrylate copolymer with a silane, in the presence of an organo titanate catalyst (see abstract). U.S. Pat. 5,068,304 discloses a moisture curable resin formed from a polyol and a polyalkoxy silane (see, for example, the abstract and claim 1).

U.S. Pat. 5,296,561 discloses the copolymerization of a C6-C14 alpha-olefin with an ω-alkenylhalosilane or an ω-alkenylalkoxysilane, using a Ziegler-Natta catalyst, to produce a copolymer containing halosilyl or alkoxysilyl side chains. The resulting copolymer, containing halosilyl side chains, is reacted with an alcohol to create alkoxysilyl chains (see, for example, column 5, lines 24-39). Preferred Ziegler-Natta catalysts include diethylaluminum chloride/aluminum activated titanium trichloride (see column 5, lines 40-52, and column 11, line 56, to column 12, line 5). This patent also discloses a moisture curable polymer prepared by polymerizing an alpha-olefin with a conjugate diene, to produce a copolymer containing ethylenic unsaturated chains. In the presence of a hydrosilation catalyst, the ethylenic unsaturations are hydrosilated with a hydrosilane (see, for example, claim 1). See also, U.S. Pat. 5,397,648 and International Publication WO1992/05226.

The reference, Journal of Polymer Science Part A: Polymer Chemistry (2013), 51, abstract, Rapid, Metal Free Room Temperature Vulcanization Produces Silicone Elastomers, discloses the crosslinking of hydrogen-terminated silicone polymers by tri- or tetraalkoxysilane crosslinkers, in a condensation process catalyzed by trispentafluorophenylborane (see abstract), U.S. Pat. 6,624,254 discloses the syntheses of silane functionalized polymers, and polymer conversions through coupling, hydrolysis, hydrolysis and neutralization, condensation, oxidation and hydrosilation (see abstract). Conversion processes also include alcoholysis under basic or acidic conditions (see, for example, column 24, lines 57, to column 25, line 8, and claim 1). Polyfunctional linker compounds can be used to modify and crosslink the polymers (column 26, lines 27-45). Additives that accelerate the reactions, such as hydrolysis and condensation reactions, include Lewis bases and organometallic compounds (column 27, lines 20-47). See also, U.S. Pat. 6,258,902 and European Patent EP1259556B1.

There remains a need for new crosslinking reactions of olefin-based polymers that do not require prior processing step(s). This need has been met in the following invention (first and second aspects) as described below.

There is also a need for reactions that can readily and predictably convert an olefin/silane interpolymer to an olefin/alkoxysilane interpolymer, and which converted interpolymer can be easily processed on conventional thermoplastic equipment to form an end product, which can be cured off-line by exposure to moisture. Much of the current technology used to synthesize “alkoxysilane-containing” olefin-based interpolymers is based on a radical grafting approach.

International Publication WO 2005/118682 discloses a silicone condensation reaction between an alkoxy silane or siloxane and an organo-hydrosilane or siloxane, using a Lewis acid catalyst (see abstract). U.S. Pat. 5,824,718 discloses ethylene-based polymers grafted with a silane crosslinker, using radical chemistry. U.S. Pat. 6,331,597 discloses moisture-curable polyolefins, using azidosilane grafting agents. The polymer and azidosilane mixture is heated to affect the decomposition of the azide functional group. European Application EP0321259A2 discloses the polymerization of a alkenyl silane and an alpha-olefin in the presence of a catalyst containing a titanium compound supported on a carrier of magnesium halide, and an organic aluminum compound (see abstract). See U.S. Pat. 5,296,561 discussed above. See also, U.S. Pat. 5,397,648 and International Publication WO1992/05226. See U.S. Pat. 6,624,254 discussed above. See also, U.S. Pat. 6,258,902 and EP1259556B1.

However, as discussed, there is a need for reactions that can readily and predictably convert an olefin/silane interpolymer to an olefin/alkoxysilane interpolymer, and which interpolymer can be processed and cured using conventional equipment. These needs have been met in the following invention (third and fourth aspects) as described below.

### SUMMARY OF THE INVENTION

In a first aspect, a process to form a crosslinked composition, said process comprising thermally treating a composition at a temperature ≥ 25° C., in the presence of moisture, and wherein the composition comprises the following components:
a) an olefin/silane interpolymer,
b) a cure catalyst selected from the following compounds i)-vi):
   i) a metal alkoxide,
   ii) a metal carboxylate,
   iii) a metal sulfonate,
   iv) an aryl sulfonic acid,
   v) a tris-aryl borane,
   vi) any combination of two or more from i)-v).

In a second aspect, a composition comprising the following components:
a) an olefin/silane interpolymer,
b) a cure catalyst selected from the following compounds i)-vi):
   i) a metal alkoxide,
   ii) a metal carboxylate,
   iii) a metal sulfonate,
   iv) an aryl sulfonic acid,
   v) a tris-aryl borane,
   vi) any combination of two or more from i)-v).

In a third aspect, a process to form an olefin/alkoxysilane interpolymer, said process comprising thermally treating a composition comprising the following components:
a) an olefin/silane interpolymer,
b) an alcohol,
c) a Lewis acid.

In a fourth aspect, a composition comprising an olefin/alkoxysilane interpolymer that has a molecular weight distribution (MWD) from 1.6 to 5.0, and that comprises from 0.20 wt% to 40 wt% of the alkoxysilane derived monomer, based on the weight of the interpolymer.

### BRIEF DESCRIPTION OF THE DRAWINGS

FIG. 1 depicts DMA profiles (G′ vs. Temp., G″ vs. Temp., and Tan Delta vs. Temp.) of a control composition (Terpolymer 1).

FIG. 2 depicts DMA profiles (G′ vs. Temp., G″ vs. Temp., and Tan Delta vs. Temp.) of a composition (Terpolymer 1 and dibutyltindilaurate) that was not subject to moisture cure.

FIG. 3 depicts DMA profiles (G′ vs. Temp., G″ vs. Temp., and Tan Delta vs. Temp.) of a composition (Terpolymer 1 and dibutyltindilaurate) that was subject to moisture cure at 85C/85% RH for 6 days.

For FIGS. 1-3, at a reference temperature of 38° C., the order of profiles from top to bottom is as follows: G′ vs. Temp., G″ vs. Temp., and Tan Delta vs. Temp.

FIG. 4 depicts DMA profiles (G′ vs. Temp.) of the following compositions: Terpolymer 2 and no DBSA, Terpolymer 2 and DBSA (2000 ppm) - subject to air cure at 85° C. for 1 day, Terpolymer 2 and DBSA (2000 ppm) - subject to air cure at 85° C. for 5 days. FIG. 4 also lists the gel content for each composition.

FIG. 5 depicts DMA profiles (G′ vs. Temp.) of compositions containing Terpolymer 1 and with FAB (50, 100 and 200 ppm) or without FAB, and subject to moisture cure at 85 C/85% RH for 6 days.

FIG. 6 depicts DMA profiles (G′ vs. Temp.) of compositions containing Terpolymer 1 and with DBU (1000 ppm) or without DBU; those compositions with DBU were either not subject to moisture cure, or subject to moisture cure at 85 C/85%RH for 7 days.

FIG. 7 depicts the 1H NMR profile of Ethylene/Alkoxysilane Copolymer 1A.

FIG. 8 depicts the GPC profile of Ethylene/Alkoxysilane Copolymer 1B.

### DETAILED DRESCRIPTION OF THE INVENTION

A curing process for olefin/silane interpolymers has been discovered, and which provides high levels of crosslinking, and does not require the prior chemical modification of the interpolymer. The interpolymer, before and after crosslinking, can be processed on conventional equipment of the art. Also, the crosslinking density can be controlled by adjusting the amount of silane groups in the interpolymer.

A process to form a crosslinked composition is provided, as noted in the first aspect of the invention discussed above. Also, a composition is provided, as noted in the second aspect of the invention discussed above. The above process (first aspect) may comprise a combination of two or more embodiments, as described herein. The above composition (second aspect) may comprise a combination of two or more embodiments, as described herein. Each component a and b may comprise a combination of two or more embodiments, as described herein.

It has also been discovered that olefin/silane interpolymers can be readily converted to olefin/alkoxysilane interpolymers by a reaction with an alcohol ROH (for example, methanol, ethanol, or isopropanol) in the presence of catalytic amount of a Lewis acid (for example, B(C₆F₅)₃). See the following reaction schematic. This process will allow for the control of the amount of functionalization and the crosslinking density by adjusting the amount of silane groups in the interpolymer.

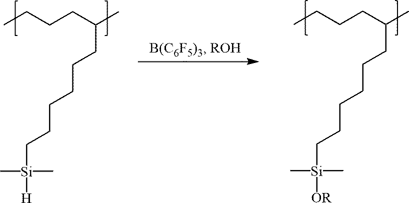

Thus, a process to form an olefin/alkoxysilane interpolymer is provided, as noted in the third aspect of the invention discussed above. Also, a composition is provided, as noted in the fourth aspect of the invention discussed above. The process (third aspect) may comprise a combination of two or more embodiments, as described herein. The above composition (fourth aspect) may comprise a combination of two or more embodiments, as described herein. Each component a, b and c may comprise a combination of two or more embodiments, as described herein.

The following embodiments apply to the first and second aspects of the invention.

In one embodiment, or a combination of two or more embodiments, each described herein, the thermal treatment takes place at a RH (Relative Humidity) ≥ 5%, or ≥ 10%, or ≥ 15%, or ≥ 20%, or ≥ 25%, or ≥ 30%, or ≥ 35%, or ≥ 40%, or ≥ 45%, or ≥ 50%, or ≥ 55%, or ≥ 60%, or ≥ 65%, or ≥ 70%, or ≥ 75%, or ≥ 80%.

In one embodiment, or a combination of two or more embodiments, each described herein, the moisture comprises moisture originating from adsorbed and/or absorbed water on the cure catalyst, and further adsorbed water on the cure catalyst.

In one embodiment, or a combination of two or more embodiments, each described herein, the compound i) is selected from c1): M—[O(H)—(CH₂)n—CH₃]₄ c1), where M = Ti or Sn, and n ≥ 1, and further M = Ti, and further n = 2 - 10, or n = 2 - 8, or n = 2 - 6, or n = 2 to 4, or n = 2 to 3.

In one embodiment, or a combination of two or more embodiments, each described herein, the compound ii) is selected from c2): (CₙH₂ₙ₊₁)₂—M—[O—C(O)—CₘH₂ₘ₊₁]₂ _{c2)}, where M= Ti or Sn, n ≥ 1, and m ≥ 3; and further M = Sn, and further n = 1 - 10 and m = 2 -20; or n = 2 - 8 and m = 4 - 18, or n = 2 - 6 and m = 6 - 16, or n = 2 - 4 and m = 6 - 14.

In one embodiment, or a combination of two or more embodiments, each described herein, the compound iv) is selected from c4) or c4′):

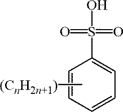

c4), where n ≥ 3, and further n = 4 - 20; further n = 6 - 18, further n = 6 - 16, further n = 6 - 14, further n = 6 - 12; or

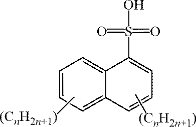

c4′), where n ≥ 3, and further n = 4 - 20; further n = 6 - 20, further n = 6 - 18, further n = 6 - 16, further n = 6 - 14.

In one embodiment, or a combination of two or more embodiments, each described herein, the compound v) is tris(pentafluorophenyl)borane (c5).

In one embodiment, or a combination of two or more embodiments, each described herein, the cure catalyst of component b) is selected from compounds c1), c2), c3), c4), c4′) c5) or any combination thereof, and further from compounds c1), c2), c4), c4′), c5) or any combination thereof.

In one embodiment, or a combination of two or more embodiments, each described herein, the cure catalyst of component b) selected from the following: dibutyltindilaurate, tetrabutyl titanium oxide, dodecylbenezene sulfonic acid, bismuth trifluorosulfonate, or tris(pentafluorophenyl)borane (FAB) and further dibutyltindilaurate, tetrabutyl titanium oxide, dodecylbenezene sulfonic acid, or tris(pentafluorophenyl)borane.

In one embodiment, or a combination of two or more embodiments, each described herein, the cure catalyst of component b) is selected from the following: i), ii), or iv)-vi).

In one embodiment, or a combination of two or more embodiments, each described herein, the olefin/silane interpolymer (component a) is an ethylene/alpha-olefin/silane interpolymer, and further an ethylene/alpha-olefin/silane terpolymer.

In one embodiment, or a combination of two or more embodiments, each described herein, the silane of the olefin/silane interpolymer is derived from a monomer selected from the following: H₂C═CH—R1—Si(R)(R′)—H, where R1 is an alkylene, and R and R′ are each independently an alkyl, and R and R′ may be the same or different.

Also provided is a crosslinked composition formed from the composition of any one embodiment, or from a combination of two or more embodiments, each described herein.

In one embodiment, or a combination of two or more embodiments, each described herein, the crosslinked composition has a gel content ≥ 30 wt%, or ≥ 35 wt%, or ≥ 40 wt%, or ≥ 45 wt%, or ≥ 50 wt%, or ≥ 55 wt%, or ≥ 60 wt%, or ≥ 65 wt%, or ≥ 70 wt%, or ≥ 75 wt%, based on the weight of the crosslinked composition. In one embodiment, or a combination of two or more embodiments, each described herein, the crosslinked composition has a gel content ≤ 100 wt%, or ≤ 98 wt%, or ≤ 96 wt%, or ≤ 94 wt%, or ≤ 92 wt%, or ≤ 90 wt%, based on the weight of the crosslinked composition.

Also provided is an article comprising at least one component formed from the composition of any one embodiment, or from a combination of two or more embodiments, each described herein.

The following embodiments apply to the third and fourth aspects of the invention.

In one embodiment, or a combination of two or more embodiments, each described herein, component c is selected from the following i)-vi):
i) B(R¹)(R²)(R³), where each of R¹, R² and R³ is, independently, a substituted or unsubstituted aryl group, and further a substituted aryl group,
ii) BX₃, where X is a halo group,
iii) AlR₃, where R is a substituted or unsubstituted alkyl group,
iv) AlX₃, where X is a halo group,
v) SiX₄, where X is a halo group,
vi) any combination of two or more from i)-v).

As used herein, the term “substituted,” in reference to an alkyl group or an aryl group, refers to the replacement of one or more hydrogen atoms with one or more chemical group(s) comprising at least one heteroatom, such as F.

In one embodiment, or a combination of two or more embodiments, each described herein, component c is B(C₆F₅)₃.

In one embodiment, or a combination of two or more embodiments, each described herein, component b is selected from the following: CₙH₂ₙ₊₁OH, where n ≥ 1, and further n is from 1 to 20, further from 1 to 10, further from 1 to 5, further from 1 to 3.

In one embodiment, or a combination of two or more embodiments, each described herein, the olefin/silane interpolymer (component a) is an ethylene/silane interpolymer, and further an ethylene/silane copolymer.

In one embodiment, or a combination of two or more embodiments, each described herein, the silane of the olefin/silane interpolymer (component a) is derived from a monomer selected from the following: H₂C═CH—R1—Si(R)(R′)—H, where R1 is an alkylene, and R and R′ are each independently an alkyl, and R and R′ may be the same or different.

Also provided is a composition comprising an olefin/alkoxysilane interpolymer formed from the process of any one embodiment, or from a combination of two or more embodiments, each described herein.

In one embodiment, or a combination of two or more embodiments, each described herein, the olefin/alkoxysilane interpolymer comprises, in polymerize form, from ≥ 0.20 wt%, or ≥ 0.40 wt%, or ≥ 0.60 wt%, or ≥ 0.80 wt%, or ≥ 1.0 wt%, or ≥ 1.5 wt%, or ≥ 2.0 wt%, or ≥ 2.5 wt%, or ≥ 3.0 wt% of the alkoxysilane derived monomer (formed from the polymerized silane monomer), based on the weight of the interpolymer. In one embodiment, or a combination of two or more embodiments, each described herein, the olefin/alkoxysilane interpolymer comprises, in polymerize form, from ≤ 40 wt%, or ≤ 35 wt%, or ≤ 30 wt%, or ≤ 25 wt%, or ≤ 20 wt%, or ≤ 18 wt%, or ≤ 16 wt%, or ≤ 14 wt%, or ≤ 12 wt%, or ≤ 10 wt%, or ≤ 8.0 wt%, or ≤ 6.0 wt%, of ≤ 4.0 wt% of the alkoxysilane derived monomer, based on the weight of the interpolymer.

In one embodiment, or a combination of two or more embodiments, each described herein, the olefin/alkoxysilane interpolymer has a molecular weight distribution (MWD = Mw/Mn) ≥ 1.6, or ≥ 1.8, or ≥ 2.0, or ≥ 2.5. In one embodiment, or a combination of two or more embodiments, each described herein, the olefin/alkoxysilane interpolymer has a molecular weight distribution MWD ≤ 5.0, or ≤ 4.5, or ≤ 4.0, or ≤ 3.8, or ≤ 3.6.

Also provided is a crosslinked composition formed by thermally treating, in the presence of moisture, the composition of any one embodiment, or from a combination of two or more embodiments, each described herein.

Also provided is an article comprising at least one component formed from the composition of any one embodiment, or from a combination of two or more embodiments, each described herein.

### Silane Monomer

A silane monomer, as used herein, comprises at least one Si-H group. In one embodiment, the silane monomer is selected from Formula 1:

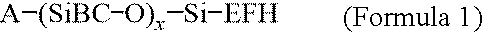

where A is an alkenyl group;
B is a hydrocarbyl group or hydrogen, C is a hydrocarbyl group or hydrogen, and where B and C may be the same or different;
H is hydrogen, and x ≥ 0;
E is a hydrocarbyl group or hydrogen, F is a hydrocarbyl group or hydrogen, and where E and F may be the same or different.

Some examples of silane monomers include hexenylsilane, allylsilane, vinylsilane, octenylsilane, hexenyldimethylsilane, octenyldimethylsilane, vinyldimethylsilane, vinyl-diethylsilane, vinyldi(n-butyl)silane, vinylmethyloctadecylsilane, vinyidiphenylsilane, vinyldibenzylsilane, allyldimethylsilane, allyldiethylsilane, allyldi(n-butyl)silane, allylmethyloctadecylsilane, allyldiphenylsilane, bishexenylsilane, and allyidibenzylsilane. Mixtures of the foregoing alkenylsilanes may also be used.

More specific examples of silane monomers include the following: (5-hexenyldimethylsilane (HDMS), 7-octenyldimethylsilane (ODMS), allyldimethylsilane (ADMS), 3-butenyldimethylsilane, 1-(but-3-en-1-yl)-1,1,3,3-tetramethyldisiloxane (BuMMH), 1-(hex-5-en-1-yl)-1,1,3,3-tetramethyldisiloxane (HexMMH), (2-bicyclo[2.2.1]hept-5-en-2-yl)ethyl)-dimethylsilane (NorDMS) and 1-(2-bicyclo[2.2.1]hept-5-en-2-yl)ethyl)-1,1,3,3-tetramethyldisiloxane (NorMMH).

### Cure Catalysts

A cure catalyst, as used herein, is a compound that accelerates the reaction, in the presence of moisture, between pendant silane moieties, for example, —Si(R¹)(R²)H, of two or more olefin/silane interpolymer chains. Examples of cure catalysts include metal alkoxides, metal carboxylates, metal sulfonates, aryl sulfonic acids and tris-aryl boranes.

A metal alkoxide is typically represented by M(OR)ₙ, where M is a metal, and R is an alkyl group, and n ≥ 1. In one embodiment, M is Ti or Sn.

A metal carboxylate is typically represented by M[O—C(O)—R]ₘ, where M is a metal, R is an alkyl and m ≥ 1, or by (R′)ₙM[O—C(O)—R]ₘ, where R′ and R are each independently an alkyl, M is a metal, n ≥ 1 and m ≥ 1. In one embodiment, M is Ti or Sn and further Sn.

A metal sulfonate is typically represented M[OS(O)₂R]ₙ, where M is a metal, R is a substituted or unsubstituted alkyl group and n ≥ 1. For example, and one or more hydrogen atoms on the alkyl group may be substituted with halo groups, such as F. In one embodiment, M is bismuth.

An aryl sulfonic acid comprises at least one aryl group and at least one sulfonic acid group. An example of an aryl sulfonic acid is represented by Ar—S(O)₂—OH, where Ar is an aryl group containing one or more alkyl groups. The aryl group may be bicyclic, tricyclic, etc. Examples of aryl sulfonic acids are described in International Publication WO2002/12355.

A tris-aryl borane is typically represented by B(Ar)₃, where B is boron, and Ar is a is a substituted or unsubstituted aryl group. For example, and one or more hydrogen atoms on the aryl group may be substituted with halo groups, such as F.

### Lewis Acids

A Lewis acid is a chemical species that contains an empty orbital which is capable of accepting an electron pair. This term is known in the art. Some examples of Lewis acids include boron trihalides, organoboranes (for example, tris(pentafluorophenyl)borane), boron trifluoride, tetrafluorosilane (SiF₄), and aluminum trihalides (for example, AlCl₃).

### Alcohols

An alcohol is a hydrocarbon comprising an OH group (for example, ROH, where R is an alkyl). Suitable alcohols include those of formula CₙH₂ₙ₊₁OH, were n ≥ 1. Alcohols include, but are not limited to, methanol, ethanol, propanol, isopropanol, butanol, pentanol, hexanol, octanol and decanol.

### Additives

An inventive composition may comprise one or more additives. Additives include, but are not limited to, UV stabilizer, antioxidants, fillers, scorch retardants, tackifiers, waxes, compatibilizers, adhesion promoters, plasticizers, blocking agents, antiblocking agents, antistatic agents, release agents, anti-cling additives, colorants, dyes, pigments, and combinations thereof.

### DEFINITIONS

Unless stated to the contrary, implicit from the context, or customary in the art, all parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt% or a majority weight percent of an olefin, such as, for example, ethylene or propylene or octene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “octene-based polymer,” as used herein, refers to a polymer that comprises, in polymerized form, a majority weight percent of octene (based on the weight of the polymer), and optionally may comprise one or more comonomers.

The term “ethylene-based polymer,” as used herein, refers to a polymer that comprises, in polymerized form, 50 wt% or a majority weight percent of ethylene (based on the weight of the polymer), and optionally may comprise one or more comonomers.

The term “ethylene/alpha-olefin interpolymer,” as used herein, refers to a random interpolymer that comprises, in polymerized form, 50 wt% or a majority weight percent of ethylene (based on the weight of the interpolymer), and an alpha-olefin.

The term, “ethylene/alpha-olefin copolymer,” as used herein, refers to a random copolymer that comprises, in polymerized form, 50 wt% or a majority amount of ethylene monomer (based on the weight of the copolymer), and an alpha-olefin, as the only two monomer types.

The term “olefin/silane interpolymer,” as used herein, refers to a random interpolymer that comprises, in polymerized form, 50 wt% or a majority weight percent of an olefin (based on the weight of the interpolymer), and a silane monomer. As used herein, the interpolymer comprises at least one “—Si—H group,” and the phrase “at least one “—Si—H″ group” refers to a type of “—Si—H″ group. It is understood in the art that the interpolymer would contain a multiple number of this silane type. The olefin/silane interpolymer is formed by the copolymerization (for example, using a bis-biphenyl-phenoxy metal complex) of at least the olefin and the silane monomer. An example of a silane monomer is depicted in Formula 1, as described herein. The silane monomer may or may not comprise one or more siloxane (—Si—O—Si—) linkages.

The term “ethylene/silane interpolymer,” as used herein, refers to a random interpolymer that comprises, in polymerized form, 50 wt% or a majority weight percent of ethylene (based on the weight of the interpolymer), and a silane monomer. As used herein, the interpolymer comprises at least one “-Si-H″ group, as discussed above. The ethylene/silane interpolymer is formed by the copolymerization of at least the ethylene and the silane monomer. The silane monomer may or may not comprise one or more siloxane linkages.

The term “ethylene/silane copolymer,” as used herein, refers to a random copolymer that comprises, in polymerized form, 50 wt% or a majority weight percent of ethylene (based on the weight of the copolymer), and a silane monomer, as the only two monomer types. As used herein, the interpolymer comprises at least one “-Si-H″ group, as discussed above. The ethylene/silane copolymer is formed by the copolymerization of the ethylene and the silane monomer. The silane monomer may or may not comprise one or more siloxane linkages.

The term “ethylene/alpha-olefin/silane interpolymer,” as used herein, refers to a random interpolymer that comprises, in polymerized form, 50 wt% or a majority weight percent of ethylene (based on the weight of the interpolymer), an alpha-olefin and a silane monomer. As used herein, the interpolymer comprises at least one “-Si-H″ group, as discussed above. The ethylene/ alpha-olefin/silane interpolymer is formed by the copolymerization of at least the ethylene, the alpha-olefin and the silane monomer. The silane monomer may or may not comprise one or more siloxane linkages.

The term “ethylene/alpha-olefin/silane terpolymer,” as used herein, refers to a random terpolymer that comprises, in polymerized form, 50 wt% or a majority weight percent of ethylene (based on the weight of the terpolymer), an alpha-olefin and a silane monomer as the only three monomer types. As used herein, the terpolymer comprises at least one “-Si-H″ group, as discussed above. The ethylene/alpha-olefin/silane terpolymer is formed by the copolymerization of the ethylene, the alpha-olefin and the silane monomer. The silane monomer may or may not comprise one or more siloxane linkages.

The term “olefin/alkoxysilane interpolymer,” as used herein, refers to a random interpolymer that comprises, in polymerized form, 50 wt% or a majority weight percent of an olefin (based on the weight of the interpolymer), and an alkoxysilane formed from a polymerized silane monomer and an alcohol. As used herein, the interpolymer comprises at least one “-Si-OR group,” where R is a hydrocarbon, and the phrase “at least one “-Si-OR″ group” refers to a type of “Si-OR″ group. It is understood in the art that the interpolymer would contain a multiple number of this alkoxysilane type. The silane monomer may or may not comprise one or more siloxane linkages.

The term “ethylene/alkoxysilane interpolymer,” as used herein, refers to a random interpolymer that comprises, in polymerized form, 50 wt% or a majority weight percent of ethylene (based on the weight of the interpolymer), and an alkoxysilane formed from a polymerized silane monomer and an alcohol. As used herein, the interpolymer comprises at least one “-Si-OR group,” as discussed above. The silane monomer may or may not comprise one or more siloxane linkages.

The term “ethylene/alkoxysilane copolymer,” as used herein, refers to a random copolymer that comprises, in polymerized form, 50 wt% or a majority weight percent of ethylene (based on the weight of the copolymer), and an alkoxysilane formed from a polymerized silane monomer and an alcohol. The ethylene and silane monomer are the only two monomer types. As used herein, the interpolymer comprises at least one “-Si-OR group,” as discussed above. The silane monomer may or may not comprise one or more siloxane linkages.

The term “ethylene/alpha-olefin/alkoxysilane interpolymer,” as used herein, refers to a random interpolymer that comprises, in polymerized form, 50 wt% or a majority weight percent of ethylene (based on the weight of the interpolymer), an alpha-olefin and an alkoxysilane formed from a polymerized silane monomer and an alcohol. As used herein, the interpolymer comprises at least one “-Si-OR group,” as discussed above. The silane monomer may or may not comprise one or more siloxane linkages.

The term “ethylene/alpha-olefin/alkoxysilane terpolymer,” as used herein, refers to a random terpolymer that comprises, in polymerized form, 50 wt% or a majority weight percent of ethylene (based on the weight of the terpolymer), an alpha-olefin and an alkoxysilane formed from a polymerized silane monomer and an alcohol. The ethylene, alpha-olefin and silane monomer are the only three monomer types. As used herein, the interpolymer comprises at least one “-Si-OR group,” as discussed above. The silane monomer may or may not comprise one or more siloxane linkages.

The phrase “a majority weight percent,” as used herein, in reference to a polymer (or interpolymer or terpolymer or copolymer), refers to the amount of monomer present in the greatest amount in the polymer.

The terms “hydrocarbon group,” “hydrocarbyl group,” and similar terms, as used herein, refer to a chemical group containing only carbon and hydrogen atoms.

As used herein, in reference to chemical formulas or structures, R1 = R¹, R2 = R², R3 = R³, and so forth.

The term “crosslinked composition,” as used herein, refers to a composition that has a network structure due to the formation of chemical bonds between polymer chains. The degree of formation of this network structure is indicated by the increase in the complex viscosity or shear storage modulus of the melt, as discussed herein, or by an increase in gel content.

The term “crosslinked olefin/silane interpolymer,” and similar terms, as used herein, refer to an olefin/silane interpolymer that has a network structure due to the formation of chemical bonds between polymer chains. The degree of formation of this network structure is indicated by the increase in the complex viscosity or shear storage modulus of the melt, as discussed herein, or by an increase in gel content. The term “crosslinked olefin/alkoxysilane interpolymer” and similar terms are similarly described.

The terms “thermally treating,” “thermal treatment,” and similar terms, as used herein, in reference to a composition comprising, for example, an olefin/silane interpolymer or an olefin/alkoxysilane interpolymer, refer to the application of heat to the composition. Heat may be applied by conduction (for example, a heating coil), by convection (for example, heat transfer through a fluid, such as water or air), and/or by radiation (for example, heat transfer using electromagnetic waves). Preferably heat is applied by conduction or convection. Note, the temperature at which the thermal treatment takes place, refers to the internal temperature of the oven or other device used to cure (or crosslink) the interpolymer.

The phrase “in the presence of moisture,” as used herein, refers to the presence of an atmosphere that comprises water. The amount of water in the atmosphere may be indicated by a %RH (Relative Humidity), as described herein.

The term “alkenyl group,” as used herein, refers to an organic chemical group that contains at least one carbon-carbon double bond (C=C). In a preferred embodiment, the alkenyl group is a hydrocarbon group containing at least one carbon-carbon double bond, and further containing only one carbon-carbon double bond.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Process and Composition Features

A] A process to form a crosslinked composition, said process comprising thermally treating a composition at a temperature ≥ 25° C., and in the presence of moisture (H₂O), and wherein the composition comprises the following components:
a) an olefin/silane interpolymer,
b) a cure catalyst selected from the following compounds i)-vi):
   i) a metal alkoxide,
   ii) a metal carboxylate,
   iii) a metal sulfonate,
   iv) an aryl sulfonic acid,
   v) a tris-aryl borane,
   vi) any combination of two or more from i)-v).

B] The process of A] above, wherein the thermal treatment takes place at a RH (Relative Humidity) ≥ 5%, or ≥ 10%, or ≥ 15%, or ≥ 20%, or ≥ 25%, or ≥ 30%, or ≥ 35%, or ≥ 40%, or ≥ 45%, or ≥ 50%, or ≥ 55%, or ≥ 60%, or ≥ 65%, or ≥ 70%, or ≥ 75%, or ≥ 80%.

C] The process of A] or B] above, wherein the thermal treatment takes place at a relative humidity (RH) ≤ 100%, or ≤ 98%, or ≤ 96%, or ≤ 94%, or ≤ 92%, or ≤ 90%, or 88%, or ≤ 86%, or ≤ 85%, or ≤ 84%, or ≤ 83%, or ≤ 82%.

D] The process of A] above, wherein the moisture comprises moisture originating from adsorbed and/or absorbed water on the cure catalyst, and further from adsorbed water on the cure catalyst.

E] The process of any one of A]-D] (A] through D]) above, wherein compound i) is selected from c1): M—[O(H)—(CH₂)ₙ—CH₃]₄ c1), where M = Ti or Sn, and n ≥ 1, and further M = Ti, and further n = 2 - 10, or n = 2 - 8, or n = 2 - 6, or n = 2 to 4, or n = 2 to 3.

F] The process of any one of A]-E] above, wherein compound ii) is selected from c2): (CₙH₂ₙ₊₁)₂—M—[O—C(O)—CₘH₂ₘ₊₁]₂ _{c2)}, where M= Ti or Sn, n ≥ 1, and m ≥ 3; and further M = Sn, and further n = 1 - 10 and m = 2 - 20; or n = 2 - 8 and m = 4 - 18, or n = 2 - 6 and m = 6 - 16, or n = 2 - 4 and m = 6 - 14.

G] The process of any one of A]-F] above, wherein compound iii) is bismuth trifluorosulfonate (c3).

H] The process of any one of A]-G] above, wherein the compound iv) is selected from c4) or c4′):

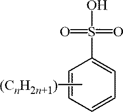

c4), where n ≥ 3, and further n = 4 - 20; further n = 6 - 18, further n = 6 - 16, further n = 6 - 14, further n = 6 - 12; or

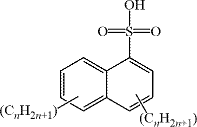

c4′), where n ≥ 3, and further n = 4 - 20; further n = 6 - 20, further n = 6 - 18, further n = 6 - 16, further n = 6 - 14.

I] The process of any one of A]-H] above, wherein compound iv) is selected from c4):

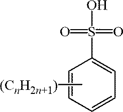

c4), where n ≥ 3, and further, n = 4 - 20; further n = 6 - 18, further n = 6 -16, further n = 6 - 14, further n = 6 - 12.

J] The process of any one of A]-I] above, wherein compound v) is tris(pentafluorophenyl)borane (c5).

K] The process of any one of A]-J] above, wherein the cure catalyst of component b) is selected from compounds c1), c2), c3), c4), c4′), c5) or any combination thereof, and further from compounds c1), c2), c4), c4′), c5) or any combination thereof, and further from compounds c1), c2), c4), c5) or any combination thereof.

L] The process of any one of A]-K] above, wherein the cure catalyst of component b) is selected from the following: dibutyltindilaurate, tetrabutyl titanium oxide, dodecylbenezene sulfonic acid, bismuth trifluorosulfonate, or tris(pentafluorophenyl)borane (FAB) and further dibutyltindilaurate, tetrabutyl titanium oxide, dodecylbenezene sulfonic acid, or tris(pentafluorophenyl)borane.

M] The process of any one of A]-L] above, wherein the cure catalyst of component b) is selected from the following compounds i), ii), or iv)-vi).

N] The process of any one of A]-M] above, wherein the cure catalyst of component b) is selected from compound i).

O] The process of any one of A]-M] above, wherein the cure catalyst of component b) is selected from compound ii).

P] The process of any one of A]-M] above, wherein the cure catalyst of component b) is selected from compound iv).

Q] The process of any one of A]-M] above, wherein the cure catalyst of component b) is selected from compound v).

R] The process of any one of A]-Q] above, wherein the olefin/silane interpolymer (component a) is an ethylene/alpha-olefin/silane interpolymer, and further an ethylene/alpha-olefin/silane terpolymer.

S] The process of R] above, wherein the alpha-olefin of the ethylene/alpha-olefin/silane interpolymer is a C3-C20 alpha-olefin, and further a C3-C10 alpha-olefin, and further propylene, 1-butene, 1-hexene, 1-octene and 1-decene, and further propylene, 1-butene, 1-hexene or 1-octene, and further propylene, 1-butene, or 1-octene, and further1-butene or 1-octene, further 1-octene.

T] the process of any one of A]-S] above, wherein the silane of the olefin/silane interpolymer is derived from a monomer selected from the following: H₂C═CH—R1—Si(R)(R′)—H, where R1 is an alkylene, and R and R′ are each independently an alkyl, and R and R′ may be the same or different.

U] the process of any one of A]-T] above, wherein the silane of the olefin/silane interpolymer is derived from a monomer selected from the following:

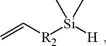

where R₂ is an alkylene.

V] the process of any one of A]-U] above, wherein the silane of the olefin/silane interpolymer is derived from a monomer selected from the following:

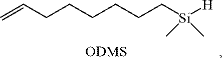

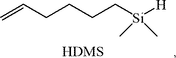

or

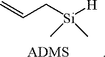

W] The process of any one of A]-V] above, wherein the composition is thermally treated at a temperature ≥ 30° C., or ≥ 35° C., or ≥ 40° C., or ≥ 45° C., or ≥ 50° C., or ≥ 55° C., or ≥ 60° C., or ≥ 65° C., or ≥ 70° C., or ≥ 75° C., or ≥ 80° C., or ≥ 90° C., or ≥ 100° C., or ≥ 110° C., or ≥ 120° C., or ≥ 130° C., or ≥ 140° C., or ≥ 150° C., or ≥ 160° C., or ≥ 170° C., or ≥ 180° C., or ≥ 185° C.

X] The process of any one of A]-W] above, wherein the composition is thermally treated at a temperature ≤ 215° C., or ≤ 210° C., or ≤ 205° C., or ≤ 200° C., or ≤ 195° C., or ≤ 190° C.

Y] The process of any one of A]-X] above, wherein the composition is thermally treated in air at a relative humidity (RH) ≥ 5%, or ≥ 10%, or ≥ 15%, or ≥ 20%, or ≥ 25%, or ≥ 30%, or ≥ 35%, or ≥ 40%, or ≥ 45%, or ≥ 50%, or ≥ 55%, or ≥ 60%, or ≥ 65%, or ≥ 70%, or ≥ 75%, or ≥ 80%.

Z] The process of any one of A]-Y] above, wherein the composition is thermally treated in air at a relative humidity (RH) ≤ 100%, or ≤ 98%, or ≤ 96%, or ≤ 94%, or ≤ 92%, or ≤ 90%, or 88%, or ≤ 86%, or ≤ 85%, or ≤ 84%, or ≤ 83%, or ≤ 82%.

A2] The process of any one of A]-Z] above, wherein, before the thermal treatment in the presence of moisture, component a and component b are mixed at a melt temperature ≥ 50° C., or ≥ 55° C., or ≥ 60° C., or ≥ 65° C., or ≥ 70° C., or ≥ 75° C., or ≥ 80° C., or ≥ 85° C.

B2] The process of any one of A]-A2] above, wherein, before the thermal treatment in the presence of moisture, component a and component b are mixed at a melt temperature ≤ 180° C., or ≤ 170° C., or ≤ 160° C., or ≤ 150° C., or ≤ 140° C., or ≤ 130° C., or ≤ 120° C., or ≤ 110° C., or ≤ 100° C., or ≤ 90° C.

C2] The process of any one of A]-B2] above, wherein the weight ratio of component a to component b is ≥ 100, or ≥ 200, or ≥ 400, or ≥ 600, or ≥ 700, or ≥ 800, or ≥ 900.

D2] The process of any one of A]-C2] above, wherein the weight ratio of component a to component b is ≤ 10000, or ≤ 5000, or ≤ 2000, or ≤ 1800, or ≤ 1600, or ≤ 1400, or ≤ 1200, or ≤ 1000.

E2] The process of any one of A]-D2] above, wherein the composition comprises ≥ 50.0 wt%, or ≥ 60.0 wt%, or ≥ 70.0 wt%, or ≥ 80.0 wt%, or ≥ 85.0 wt%, or ≥ 90.0 wt%, or ≥ 95.0 wt%, or ≥ 98.0 wt%, or ≥ 99.0 wt%, of component a, based on the weight of the composition.

F2] The process of any one of A]-E2] above, wherein the composition comprises ≤ 99.9 wt%, or ≤ 99.8 wt%, or ≤ 99.7 wt%, or ≤ 99.6 wt% of component a, based on the weight of the composition.

G2] The process of any one of A]-F2] above, wherein the composition comprises ≥ 0.02 wt%, or ≥ 0.04 wt%, or ≥ 0.06 wt%, or ≥ 0.08 wt%, or ≥ 0.10 wt% of component b, based on the weight of the composition.

H2] The process of any one of A]-G2] above, wherein the composition comprises ≤ 2.00 wt%, or ≤ 1.80 wt%, or ≤ 1.60 wt%, or ≤ 1.40 wt%, or ≤ 1.20 wt%, or ≤ 1.00 wt%, or ≤ 0.80 wt%, or ≤ 0.60 wt%, or ≤ 0.40 wt%, or ≤ 0.20 wt% of component b, based on the weight of the composition.

I2] The process of any one of A]-H2] above, wherein the composition further comprises a solvent (a substance (typically a liquid at ambient conditions) that dissolves components a and b).

J2] The process of any one of A]-I2] above, wherein the composition comprises ≤ 1.0 wt, or ≤ 0.5 wt%, or ≤ 0.05 wt%, or ≤ 0.01 wt% of a solvent, based on the weight of the composition.

K2] The process of any one of A]-H2] above, wherein the composition does not comprise a solvent.

L2] The process of any one of A]-K2] above, wherein the interpolymer of component a comprises, in polymerize form, from ≥ 0.20 wt%, or ≥ 0.40 wt%, or ≥ 0.60 wt%, or ≥ 0.80 wt%, or ≥ 1.0 wt%, or ≥ 1.5 wt%, or ≥ 2.0 wt%, or ≥ 2.5 wt%, or ≥ 3.0 wt% of the silane monomer, based on the weight of the interpolymer.

M2] The process of any one of A]-L2] above, wherein the interpolymer of component a comprises, in polymerize form, from ≤ 40 wt%, or ≤ 35 wt%, or ≤ 30 wt%, or ≤ 25 wt%, or ≤ 20 wt%, or ≤ 18 wt%, or ≤ 16 wt%, or ≤ 14 wt%, or ≤ 12 wt%, or ≤ 10 wt%, or ≤ 8.0 wt%, or ≤ 6.0 wt%, of ≤ 4.0 wt% of the silane monomer, based on the weight of the interpolymer.

N2] The process of any one of A]-M2] above, wherein the interpolymer of component a comprises, in polymerize form, from ≥ 0 wt%, or ≥ 0.5 wt%, or ≥ 1.0 wt%, or ≥ 2.0 wt%, or ≥ 4.0 wt%, or ≥ 6.0 wt%, or ≥ 8.0 wt%, or ≥ 10 wt%, or ≥ 12 wt%, or ≥ 14 wt%, or ≥ 16 wt% of the alpha-olefin, based on the weight of the interpolymer.

O2] The process of any one of A]-N2] above, wherein the interpolymer of component a comprises, in polymerize form, from ≤ 70 wt%, or ≤ 60 wt%, or ≤ 50 wt%, or ≤ 40 wt%, or ≤ 35 wt%, or ≤ 30 wt%, or ≤ 25 wt%, or ≤ 20 wt% of the alpha-olefin, based on the weight of the interpolymer.

P2] The process of any one of A]-O2] above, wherein the interpolymer of component a comprises, in polymerize form, from ≥ 0.10 mol%, or ≥ 0.20 mol%, or ≥ 0.30 mol%, or ≥ 0.40 mol%, or ≥ 0.50 mol%, or ≥ 0.60 mol% of the silane monomer, based on the total moles of monomers in the interpolymer.

Q2] The process of any one of A]-P2] above, wherein the interpolymer of component a comprises, in polymerize form, from ≤ 20 mol%, or ≤ 15 mol%, or ≤ 10 mol%, or ≤ 5.0 mol%, or ≤ 4.5 mol%, or ≤ 4.0 mol%, or ≤ 3.5 mol%, or ≤ 3.0 mol%, or ≤ 2.5 mol%, or ≤ 2.0 mol%, or ≤ 1.5 mol%, of ≤ 1.0 mol% of the silane monomer, based on the total moles of monomers in the interpolymer.

R2] The process of any one of A]-Q2] above, wherein the interpolymer of component a comprises, in polymerize form, from ≥ 0, or ≥ 0.5 mol%, or ≥ 1.0 mol%, or ≥ 2.0 mol%, or ≥ 3.0 mol%, or ≥ 3.5 mol%, or ≥ 4.0 mol%, or ≥ 4.5 mol% of the alpha-olefin, based on the total moles of monomers in the interpolymer.

S2] The process of any one of A]-R2] above, wherein the interpolymer of component a comprises, in polymerize form, from ≤ 40 mol%, or ≤ 35 mol%, or ≤ 30 mol%, or ≤ 25 mol%, or ≤ 20 mol%, or ≤ 18 mol%, or ≤ 16 mol%, or ≤ 14 mol%, or ≤ 12 mol%, or ≤ 10 mol%, or ≤ 8.0 mol%, or ≤ 6.0 mol% of the alpha-olefin, based on the total moles of monomers in the interpolymer.

T2] The process of any one of A]-S2] above, wherein the interpolymer of component a has a molecular weight distribution (MWD = Mw/Mn) ≥ 1.8, or ≥ 2.0, or ≥ 2.2, or ≥ 2.4.

U2] The process of any one of A]-T2] above, wherein the interpolymer of component a has a molecular weight distribution MWD ≤ 5.0, or ≤ 4.5, or ≤ 4.0, or ≤ 3.8, or ≤ 3.6.

V2] The process of any one of A]-U2] above, wherein the interpolymer of component a has a number average molecular weight (Mn) ≥ 10,000 g/mol, or ≥ 15,000 g/mol, or ≥ 20,000 g/mol ≥ 22,000 g/mol, or ≥ 24,000 g/mol, or ≥ 26,000 g/mol, or ≥ 28,000 g/mol.

W2] The process of any one of A]-V2] above, wherein the interpolymer of component a has a number average molecular weight (Mn) ≤ 100,000 g/mol, or ≤ 95,000 g/mol, or ≤ 90,000 g/mol, or ≤ 85,000 g/mol, or ≤ 80,000 g/mol, or ≤ 75,000 g/mol, or ≤ 70,000 g/mol, or ≤ 65,000 g/mol, or ≤ 60,000 g/mol, or ≤ 55,000 g/mol, or ≤ 50,000 g/mol.

X2] The process of any one of A]-W2] above, wherein the interpolymer of component a has a weight average molecular weight (Mw) ≥ 40,000 g/mol, or ≥ 50,000 g/mol, or ≥ 60,000 g/mol, or ≥ 70,000 g/mol, or ≥ 80,000 g/mol, or ≥ 90,000 g/mol, or ≥ 100,000 g/mol.

Y2] The process of any one of A]-X2] above, wherein the interpolymer of component a has a weight average molecular weight (Mw) ≤ 500,000 g/mol, or ≤ 400,000 g/mol, or ≤ 350,000 g/mol, or ≤ 300,000 g/mol, or ≤ 280,000 g/mol, or ≤ 260,000 g/mol, or ≤ 240,000 g/mol, or ≤ 220,000 g/mol, or ≤ 200,000 g/mol.

Z2] The process of any one of A]-Y2] above, wherein the composition further comprises a thermoplastic polymer, different from the olefin/silane interpolymer of component a in one or more features, such as monomer(s) types and/or amounts, Mn, Mw, MWD, or any combination thereof.

A3] A crosslinked composition formed from the process of any one of A]-Z2] above.

B3] The crosslinked composition of A3] above, wherein the crosslinked composition has a gel content ≥ 30 wt%, or ≥ 35 wt%, or ≥ 40 wt%, or ≥ 45 wt%, or ≥ 50 wt%, or ≥ 55 wt%, or ≥ 60 wt%, or ≥ 65 wt%, or ≥ 70 wt%, or ≥ 75 wt%, based on the weight of the crosslinked composition.

C3] The crosslinked composition of A3] of B3] above, wherein the crosslinked composition has a gel content ≤ 100 wt%, or ≤ 98 wt%, or ≤ 96 wt%, or ≤ 94 wt%, or ≤ 92 wt%, or ≤ 90 wt%, based on the weight of the crosslinked composition.

D3] A composition comprising the following components:
a) an olefin/silane interpolymer,
b) a cure catalyst selected from the following compounds i)-vi):
   i) a metal alkoxide,
   ii) a metal carboxylate,
   iii) a metal sulfonate,
   iv) an aryl sulfonic acid,
   v) a tris-aryl borane,
   vi) any combination of two or more from i)-v).

E3] The composition of D3] above, wherein compound i) is selected from c1): where M = Ti or Sn, and n ≥ 1, and further M = Ti, and further n = 2 - 10, or n = 2 - 8, or n = 2 - 6, or n = 2 to 4, or n = 2 to 3.

F3] The composition of D3] or E3] above, wherein compound ii) is selected from c2): where M= Ti or Sn, n ≥ 1, and m ≥ 3; and further M = Sn, and further n = 1 - 10 and m = 2 - 20; or n = 2 - 8 and m = 4 - 18, or n = 2 - 6 and m = 6 - 16, or n = 2 - 4 and m = 6 - 14.

G3] The composition of any one of D3]-F3] above, wherein compound iii) is bismuth trifluorosulfonate (c3).

H3] The composition of any one of D3]-G3] above, wherein the compound iv) is selected from c4), as described above, or c4′), as described above.

I3] The composition of any one of D3]-H3] above, wherein compound iv) is selected from c4), as described above.

J3] The composition of any one of D3]-I3] above, wherein compound v) is tris(pentafluorophenyl)-borane (c5).

K3] The composition of any one of D3]-J3] above, wherein the cure catalyst of component b) is selected from compounds c1), c2), c3), c4), c4′) c5) or any combination thereof, and further c1), c2), c4), c4′), c5) or any combination thereof, further c1), c2), c4), c5) or any combination.

L3] The composition of any one of D3]-K3] above, wherein the cure catalyst of component b) is selected from the following: dibutyltindilaurate, tetrabutyl titanium oxide, dodecylbenezene sulfonic acid, bismuth trifluorosulfonate, or tris(pentafluorophenyl)borane (FAB) and further dibutyltindilaurate, tetrabutyl titanium oxide, dodecylbenezene sulfonic acid, or tris(pentafluorophenyl)borane.

M3] The composition of any one of D3]-L3] above, wherein the cure catalyst of component b) is selected from the following compounds i), ii), or iv)-vi).

N3] The composition of any one of D3]-M3] above, wherein the cure catalyst of component b) is selected from compound i).

O3] The composition of any one of D3]-M3] above, wherein the cure catalyst of component b) is selected from compound ii).

P3] The composition of any one of D3]-M3] above, wherein the cure catalyst of component b) is selected from compound iv).

Q3] The composition of any one of D3]-M3] above, wherein the cure catalyst of component b) is selected from compound v).

R3] The composition of any one of D3]-Q3] above, wherein the olefin/silane interpolymer (component a) is an ethylene/alpha-olefin/silane interpolymer, and further an ethylene/alpha-olefin/silane terpolymer.

S3] The composition of R3] above, wherein the alpha-olefin of the ethylene/alpha-olefin/silane interpolymer is a C3-C20 alpha-olefin, and further a C3-C10 alpha-olefin, and further propylene, 1-butene, 1-hexene, 1-octene and 1-decene, and further propylene, 1-butene, 1-hexene or 1-octene, and further propylene, 1-butene, or 1-octene, and further1-butene or 1-octene, further 1-octene.

T3] the composition of any one of D3]-S3] above, wherein the silane of the olefin/silane interpolymer is derived from a monomer selected from the following: H₂C═CH—R1—Si(R)(R′)—H, where R1 is an alkylene, and R and R′ are each independently an alkyl, and R and R′ may be the same or different.

U3] the composition of any one of D3]-T3] above, wherein the silane of the olefin/silane interpolymer is derived from a monomer selected from the following:

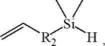

where R₂ is an alkylene.

V3] the composition of any one of D3]-U3] above, wherein the silane of the olefin/silane interpolymer is derived from a monomer selected from the following: ODMS, HDMS, or ADMS, each described above.

W3] The composition of any one of D3]-V3] above, wherein the composition is thermally treated at a temperature ≥ 30° C., or ≥ 35° C., or ≥ 40° C., or ≥ 45° C., or ≥ 50° C., or ≥ 55° C., or ≥ 60° C., or ≥ 65° C., or ≥ 70° C., or ≥ 75° C., or ≥ 80° C., or ≥ 90° C., or ≥ 100° C., or ≥ 110° C., or ≥ 120° C., or ≥ 130° C., or ≥ 140° C., or ≥ 150° C., or ≥ 160° C., or ≥ 170° C., or ≥ 180° C., or ≥ 185° C.

X3] The composition of any one of D3]-W3] above, wherein the composition is thermally treated at a temperature ≤ 215° C., or ≤ 210° C., or ≤ 205° C., or ≤ 200° C., or ≤ 195° C., or ≤ 190° C.

Y3] The composition of any one of D3]-X3] above, wherein the composition is thermally treated in the presence of moisture, and further at a relative humidity (RH) ≥ 5%, or ≥ 10%, or ≥ 15%, or ≥ 20%, or ≥ 25%, or ≥ 30%, or ≥ 35%, or ≥ 40%, or ≥ 45%, or ≥ 50%, or ≥ 55%, or ≥ 60%, or ≥ 65%, or ≥ 70%, or ≥ 75%, or ≥ 80%.

Z3] The composition of any one of D3]-Y3] above, wherein the composition is thermally treated in the presence of moisture, and further at a relative humidity (RH) ≤ 100%, or ≤ 98%, or ≤ 96%, or ≤ 94%, or ≤ 92%, or ≤ 90%, or 88%, or ≤ 86%, or ≤ 85%, or ≤ 84%, or ≤ 83%, or ≤ 82%.

A4] The composition of any one of D3]-Z3] above, wherein the weight ratio of component a to component b is ≥ 100, or ≥ 200, or ≥ 400, or ≥ 600, or ≥ 700, or ≥ 800, or ≥ 900.

B4] The composition of any one of D3]-A4] above, wherein the weight ratio of component a to component b is ≤ 10000, or ≤ 5000, or ≤ 2000, or ≤ 1800, or ≤ 1600, or ≤ 1400, or ≤ 1200, or ≤ 1000.

C4] The composition of any one of D3]-B4] above, wherein the composition comprises ≥ 50.0 wt%, or ≥ 60.0 wt%, or ≥ 70.0 wt%, or ≥ 80.0 wt%, or ≥ 85.0 wt%, or ≥ 90.0 wt%, or ≥ 95.0 wt%, or ≥ 98.0 wt%, or ≥ 99.0 wt% of component a, based on the weight of the composition.

D4] The composition of any one of D3]-C4] above, wherein the composition comprises ≤ 99.9 wt%, or ≤ 99.8 wt%, or ≤ 99.7 wt%, or ≤ 99.6 wt% of component a, based on the weight of the composition.

E4] The composition of any one of D3]-D4] above, wherein the composition comprises ≥ 0.02 wt%, or ≥ 0.04 wt%, or ≥ 0.06 wt%, or ≥ 0.08 wt%, or ≥ 0.10 wt% of component b, based on the weight of the composition.

F4] The composition of any one of D3]-E4] above, wherein the composition comprises ≤ 2.00 wt%, or ≤ 1.80 wt%, or ≤ 1.60 wt%, or ≤ 1.40 wt%, or ≤ 1.20 wt% or ≤ 1.00 wt%, or ≤ 0.80 wt%, or ≤ 0.60 wt%, or ≤ 0.40 wt%, or ≤ 0.20 wt% of component b, based on the weight of the composition.

G4] The composition of any one of D3]-F4] above, wherein the composition further comprises a solvent (a substance (typically a liquid at ambient conditions) that dissolves components a and b).

H4] The composition of any one of D3]-G4] above, wherein the composition comprises ≤1.0 wt, or ≤ 0.5 wt%, or ≤ 0.05 wt%, or ≤ 0.01 wt% of a solvent, based on the weight of the composition.

I4] The composition of any one of D3]-H4] above, wherein the composition does not comprise a solvent.

J4] The composition of any one of D3]-I4] above, wherein the interpolymer of component a comprises, in polymerize form, from ≥ 0.20 wt%, or ≥ 0.40 wt%, or ≥ 0.60 wt%, or ≥ 0.80 wt%, or ≥ 1.0 wt%, or ≥ 1.5 wt%, or ≥ 2.0 wt%, or ≥ 2.5 wt%, or ≥ 3.0 wt% of the silane monomer, based on the weight of the interpolymer.

K4] The composition of any one of D3]-J4] above, wherein the interpolymer of component a comprises, in polymerize form, from ≤ 40 wt%, or ≤ 35 wt%, or ≤ 30 wt%, or ≤ 25 wt%, or ≤ 20 wt%, or ≤ 18 wt%, or ≤ 16 wt%, or ≤ 14 wt%, or ≤ 12 wt%, or ≤ 10 wt%, or ≤ 8.0 wt%, or ≤ 6.0 wt%, of ≤ 4.0 wt% of the silane monomer, based on the weight of the interpolymer.

L4] The composition of any one of D3]-K4] above, wherein the interpolymer of component a comprises, in polymerize form, from ≥ 0 wt%, or ≥ 0.5 wt%, or ≥ 1.0 wt%, or ≥ 2.0 wt%, or ≥ 4.0 wt%, or ≥ 6.0 wt%, or ≥ 8.0 wt%, or ≥ 10 wt%, or ≥ 12 wt%, or ≥ 14 wt%, or ≥ 16 wt% of the alpha-olefin, based on the weight of the interpolymer.

M4] The composition of any one of D3]-L4] above, wherein the interpolymer of component a comprises, in polymerize form, from ≤ 70 wt%, or ≤ 60 wt%, or ≤ 50 wt%, or ≤ 40 wt%, or ≤ 35 wt%, or ≤ 30 wt%, or ≤ 25 wt%, or ≤ 20 wt% of the alpha-olefin, based on the weight of the interpolymer.

N4] The composition of any one of D3]-M4] above, wherein the interpolymer of component a has a molecular weight distribution (MWD = Mw/Mn) ≥ 1.8, or ≥ 2.0, or ≥ 2.2, or ≥ 2.4.

O4] The composition of any one of D3]-N4] above, wherein the interpolymer of component a has a molecular weight distribution MWD ≤ 5.0, or ≤ 4.5, or ≤ 4.0, or ≤ 3.8, or ≤ 3.6.

P4] The composition of any one of D3]-O4] above, wherein the interpolymer of component a has a number average molecular weight (Mn) ≥ 10,000 g/mol, or ≥ 15,000 g/mol, or ≥ 20,000 g/mol ≥ 22,000 g/mol, or ≥ 24,000 g/mol, or ≥ 26,000 g/mol, or ≥ 28,000 g/mol.

Q4] The composition of any one of D3]-P4] above, wherein the interpolymer of component a has a number average molecular weight (Mn) ≤ 100,000 g/mol, or ≤ 95,000 g/mol, or ≤ 90,000 g/mol, or ≤ 85,000 g/mol, or ≤ 80,000 g/mol, or ≤ 75,000 g/mol, or ≤ 70,000 g/mol, or ≤ 65,000 g/mol, or ≤ 60,000 g/mol, or ≤ 55,000 g/mol, or ≤ 50,000 g/mol.

R4] The composition of any one of D3]-Q4] above, wherein the interpolymer of component a has a weight average molecular weight (Mw) ≥ 40,000 g/mol, or ≥ 50,000 g/mol, or ≥ 60,000 g/mol, or ≥ 70,000 g/mol, or ≥ 80,000 g/mol, or ≥ 90,000 g/mol, or ≥ 100,000 g/mol.

S4] The composition of any one of D3]-R4] above, wherein the interpolymer of component a has a weight average molecular weight (Mw) ≤ 500,000 g/mol, or ≤ 400,000 g/mol, or ≤ 350,000 g/mol, or ≤ 300,000 g/mol, or ≤ 280,000 g/mol, or ≤ 260,000 g/mol, or ≤ 240,000 g/mol, or ≤ 220,000 g/mol, or ≤ 200,000 g/mol.

T4] The composition of any one of D3]-S4] above, wherein the composition further comprises a thermoplastic polymer, different from the olefin/silane interpolymer of component a in one or more features, such as monomer(s) types and/or amounts, Mn, Mw, MWD, or any combination thereof.

U4] A crosslinked composition formed from the composition of any one of D3]-T4] above.

V4] The crosslinked composition of U4] above, wherein the crosslinked composition has a gel content ≥ 30 wt%, or ≥ 35 wt%, or ≥ 40 wt%, or ≥ 45 wt%, or ≥ 50 wt%, or ≥ 55 wt%, or ≥ 60 wt%, or ≥ 65 wt%, or ≥ 70 wt%, or ≥ 75 wt%, based on the weight of the crosslinked composition.

W4] The crosslinked composition of U4] of V4] above, wherein the crosslinked composition has a gel content ≤ 100 wt%, or ≤ 98 wt%, or ≤ 96 wt%, or ≤ 94 wt%, or ≤ 92 wt%, or ≤ 90 wt%, based on the weight of the crosslinked composition.

X4] An article comprising at least one component formed from the composition of any one of A3]-W4] above.

A5] A process to form an olefin/alkoxysilane interpolymer, said process comprising thermally treating a composition comprising the following components:
a) an olefin/silane interpolymer,
b) an alcohol,
c) a Lewis acid.

B5] The process of A5] above, wherein component c is an organoborane.

C5] The process of A5] or B5] above, wherein component c is selected from the following i)-vi):
i) B(R¹)(R²)(R³), where each of R¹, R² and R³ is, independently, a substituted or unsubstituted aryl group, and further a substituted aryl group,
ii) BX₃, where X is a halo group,
iii) AIR₃, where R is a substituted or unsubstituted alkyl group,
iv) AlX₃, where X is a halo group,
v) SiX₄, where X is a halo group,
vi) any combination of two or more from i)-v).

D5] The process of any one of A5]-C5] above, wherein component c is selected from i), ii), or iv)-vi).

E5] The process of any one of A5]-D5] above, wherein component c is B(C₆F₅)₃.

F5] The process of any one of A5]-E5] above, wherein component b is selected from the following: CₙH₂ₙ₊₁OH, where n ≥ 1, and further n is from 1 to 20, further from 1 to 10, further from 1 to 5, further from 1 to 3.

G5] The process of any one of A5]-F5] above, wherein the olefin/silane interpolymer (component a) is an ethylene/silane interpolymer, and further an ethylene/silane copolymer.

H5] The process of any one of A5]-G5] above, wherein the olefin/silane interpolymer (component a) is an ethylene/alpha-olefin/silane interpolymer, and further an ethylene/alpha-olefin/silane terpolymer.

I5] The process of H5] above, wherein the alpha-olefin is a C3-C20 alpha-olefin, and further a C3-C10 alpha-olefin, and further propylene, 1-butene, 1-hexene, 1-octene and 1-decene, and further propylene, 1-butene, 1-hexene or 1-octene, and further propylene, 1-butene, or 1-octene, and further1-butene or 1-octene, further 1-octene.

J5] the process of any one of A5]-I5] above, wherein the silane of the olefin/silane interpolymer (component a) is derived from a monomer selected from the following: H₂C═CH—R1—Si(R)(R′)—H, where R1 is an alkylene, and R and R′ are each independently an alkyl, and R and R′ may be the same or different.

K5] the process of any one of A5]-J5] above, wherein the silane of the olefin/silane interpolymer (component a) is derived from a monomer selected from the following:

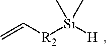

where R₂ is an alkylene.

L5] the process of any one of A5]-K5] above, wherein the silane of the olefin/silane interpolymer (component a) is derived from a monomer selected from the following: ODMS, HDMS, or ADMS, each described above.

M5] The process of any one of A5]-L5] above, wherein the composition is thermally treated at a temperature ≥ 50° C., or ≥ 60° C., or ≥ 70° C., or ≥ 80° C., or ≥ 90° C., or ≥ 100° C.

N5] The process of any one of A5]-M5] above, wherein the composition is thermally treated at a temperature ≤ 160° C., or ≤ 150° C., or ≤ 140° C., or ≤ 130° C., or ≤ 120° C., or ≤ 110° C.

O5] The process of any one of A5]-N5] above, wherein the process further comprises a solvent (a substance (typically a liquid at ambient conditions) that dissolves components a through c). The solvent is not component b.

P5] The process of any one of A5]-O5] above, wherein the process comprises ≤ 1.0 wt, or ≤ 0.5 wt%, or ≤ 0.05 wt%, or ≤ 0.01 wt% of a solvent, based on the weight of the process.

Q5] The process of any one of A5]-N5] above, wherein the process does not comprise a solvent.

R5] The process of any one of A5]-Q5] above, wherein the interpolymer of component a comprises, in polymerize form, from ≥ 0.20 wt%, or ≥ 0.40 wt%, or ≥ 0.60 wt%, or ≥ 0.80 wt%, or ≥ 1.0 wt%, or ≥ 1.5 wt%, or ≥ 2.0 wt%, or ≥ 2.5 wt%, or ≥ 3.0 wt% of the silane monomer, based on the weight of the interpolymer.

S5] The process of any one of A5]-R5] above, wherein the interpolymer of component a comprises, in polymerize form, from ≤ 40 wt%, or ≤ 35 wt%, or ≤ 30 wt%, or ≤ 25 wt%, or ≤ 20 wt%, or ≤ 18 wt%, or ≤ 16 wt%, or ≤ 14 wt%, or ≤ 12 wt%, or ≤ 10 wt%, or ≤ 8.0 wt%, or ≤ 6.0 wt%, of ≤ 4.0 wt% of the silane monomer, based on the weight of the interpolymer.

T5] The process of any one of A5]-S5] above, wherein the interpolymer of component a has a molecular weight distribution (MWD = Mw/Mn) ≥ 1.8, or ≥ 2.0, or ≥ 2.2, or ≥ 2.4.

U5] The process of any one of A5]-T5] above, wherein the interpolymer of component a has a molecular weight distribution MWD ≤ 5.0, or ≤ 4.5, or ≤ 4.0, or ≤ 3.8, or ≤ 3.6.

V5] The process of any one of A5]-U5] above, wherein the interpolymer of component a has a number average molecular weight (Mn) ≥ 10,000 g/mol, or ≥ 15,000 g/mol, or ≥ 20,000 g/mol ≥ 22,000 g/mol, or ≥ 24,000 g/mol, or ≥ 26,000 g/mol, or ≥ 28,000 g/mol.

W5] The process of any one of A5]-V5] above, wherein the interpolymer of component a has a number average molecular weight (Mn) ≤ 100,000 g/mol, or ≤ 95,000 g/mol, or ≤ 90,000 g/mol, or ≤ 85,000 g/mol, or ≤ 80,000 g/mol, or ≤ 75,000 g/mol, or ≤ 70,000 g/mol, or ≤ 65,000 g/mol, or ≤ 60,000 g/mol, or ≤ 55,000 g/mol, or ≤ 50,000 g/mol.

X5] The process of any one of A5]-W5] above, wherein the interpolymer of component a has a weight average molecular weight (Mw) ≥ 40,000 g/mol, or ≥ 50,000 g/mol, or ≥ 60,000 g/mol, or ≥ 70,000 g/mol, or ≥ 80,000 g/mol, or ≥ 90,000 g/mol, or ≥ 100,000 g/mol.

Y5] The process of any one of A5]-X5] above, wherein the interpolymer of component a has a weight average molecular weight (Mw) ≤ 500,000 g/mol, or ≤ 400,000 g/mol, or ≤ 350,000 g/mol, or ≤ 300,000 g/mol, or ≤ 280,000 g/mol, or ≤ 260,000 g/mol, or ≤ 240,000 g/mol, or ≤ 220,000 g/mol, or ≤ 200,000 g/mol.

Z5] The process of any one of A5]-Y5] above, wherein the composition further comprises a thermoplastic polymer, different from the olefin/silane interpolymer of component a in one or more features, such as monomer(s) types and/or amounts, Mn, Mw, MWD, or any combination thereof.

A6] The process of any one of A5]-Z5], wherein the molar ratio of component b to component a is ≥ 10, or ≥ 15, or ≥ 20, or ≥ 25, or ≥ 30, or ≥ 35, or ≥ 40.

B6] The process of any one of A5]-A6], wherein the molar ratio of component b to component a is ≤ 80, or ≤ 75, or ≤ 70, or ≤ 65, or ≤ 60.

C6] The process of any one of A5]-B6], wherein the molar ratio of component a to component c is ≥ 200, or ≥ 250, or ≥ 300, or ≥ 350, or ≥ 400, or ≥ 450, or ≥ 500.

D6] The process of any one of A5]-C6], wherein the molar ratio of component a to component c is ≤ 1200, or ≤ 1100, or ≤ 1000, or ≤ 900, or ≤ 800.

E6] A composition comprising an olefin/alkoxysilane interpolymer formed from the process of any one of A5]-D6] above.

F6] A composition comprising an olefin/alkoxysilane interpolymer that has a has a molecular weight distribution (MWD = Mw/Mn) from ≥ 1.6, or ≥ 1.8, or ≥ 2.0, or ≥ 2.5 to ≤ 5.0, or ≤ 4.5, or ≤ 4.0, or ≤ 3.8, or ≤ 3.6, or ≤ 3.4, or ≤ 3.2, or ≤ 3.0, or ≤ 2.8, and that comprises from ≥ 0.20 wt%, or ≥ 0.40 wt%, or ≥ 0.60 wt%, or ≥ 0.80 wt%, or ≥ 1.0 wt%, or ≥ 1.5 wt%, or ≥ 2.0 wt%, or ≥ 2.5 wt%, or ≥ 3.0 wt% to ≤ 40 wt%, or ≤ 35 wt%, or ≤ 30 wt%, or ≤ 25 wt%, or ≤ 20 wt%, or ≤ 18 wt%, or ≤ 16 wt%, or ≤ 14 wt%, or ≤ 12 wt%, or ≤ 10 wt%, or ≤ 8.0 wt%, or ≤ 6.0 wt%, of ≤ 4.0 wt% of the alkoxysilane derived monomer, based on the weight of the interpolymer.

G6] The composition of E6] above, wherein the olefin/alkoxysilane interpolymer comprises, in polymerize form, from ≥ 0.20 wt%, or ≥ 0.40 wt%, or ≥ 0.60 wt%, or ≥ 0.80 wt%, or ≥ 1.0 wt%, or ≥ 1.5 wt%, or ≥ 2.0 wt%, or ≥ 2.5 wt%, or ≥ 3.0 wt% of the alkoxysilane derived monomer, based on the weight of the interpolymer.

H6] The composition of any one of E6] or G6] above, wherein the olefin/alkoxysilane interpolymer comprises, in polymerize form, from ≤ 40 wt%, or ≤ 35 wt%, or ≤ 30 wt%, or ≤ 25 wt%, or ≤ 20 wt%, or ≤ 18 wt%, or ≤ 16 wt%, or ≤ 14 wt%, or ≤ 12 wt%, or ≤ 10 wt%, or ≤ 8.0 wt%, or ≤ 6.0 wt%, of ≤ 4.0 wt% of the alkoxysilane derived monomer, based on the weight of the interpolymer.

I6] The composition of any one of E6]-H6] above, wherein the olefin/alkoxysilane interpolymer is an ethylene/alkoxysilane interpolymer, and further an ethylene/alkoxysilane copolymer.

J6] The composition of any one of E6]-I6] above, wherein the olefin/alkoxysilane interpolymer is an ethylene/alpha-olefin/alkoxysilane interpolymer, and further an ethylene/alpha-olefin/alkoxysilane terpolymer.

K6] The composition of J6] above, wherein the alpha-olefin is a C3-C20 alpha-olefin, and further a C3-C10 alpha-olefin, and further propylene, 1-butene, 1-hexene, 1-octene and 1-decene, and further propylene, 1-butene, 1-hexene or 1-octene, and further propylene, 1-butene, or 1-octene, and further1-butene or 1-octene, further 1-octene.

L6] The composition of any one of E6] or G6]-K6] above, wherein the olefin/alkoxysilane interpolymer has a molecular weight distribution (MWD = Mw/Mn) ≥ 1.6, or ≥ 1.8, or ≥ 2.0, or ≥ 2.5.

M6] The composition of any one of E6] or G6]-L6] above, wherein the olefin/alkoxysilane interpolymer has a molecular weight distribution MWD ≤ 5.0, or ≤ 4.5, or ≤ 4.0, or ≤ 3.8, or ≤ 3.6, or ≤ 3.4, or ≤ 3.2, or ≤ 3.0, or ≤ 2.8.

N6] The composition of any one of E6]-M6] above, wherein the olefin/alkoxysilane interpolymer has a number average molecular weight (Mn) ≥ 10,000 g/mol, or ≥ 20,000 g/mol, or ≥ 30,000 g/mol ≥ 40,000 g/mol, or ≥ 50,000 g/mol ≥ 60,000 g/mol.

O6] The composition of any one of E6]-N6] above, wherein the olefin/alkoxysilane interpolymer has a number average molecular weight (Mn) ≤ 100,000 g/mol, or ≤ 95,000 g/mol, or ≤ 85,000 g/mol, or ≤ 80,000 g/mol.

P6] The composition of any one of E6]-O6] above, wherein the olefin/alkoxysilane interpolymer has a weight average molecular weight (Mw) ≥ 50,000 g/mol, or ≥ 60,000 g/mol, or ≥ 70,000 g/mol, or ≥ 80,000 g/mol, or ≥ 90,000 g/mol, or ≥ 100,000 g/mol, or ≥ 110,000 g/mol, or ≥ 120,000 g/mol, or ≥ 130,000 g/mol, or ≥ 140,000 g/mol.

Q6] The composition of any one of E6]-P6] above, wherein the olefin/alkoxysilane interpolymer has a weight average molecular weight (Mw) ≤ 300,000 g/mol, or ≤ 280,000 g/mol, or ≤ 260,000 g/mol, or ≤ 240,000 g/mol, or ≤ 220,000 g/mol, or ≤ 200,000 g/mol.

R6] The composition of any one of E6]-Q6] above, wherein the olefin/alkoxysilane interpolymer has a z average molecular weight (Ms.) ≥ 300,000 g/mol, or ≥ 320,000 g/mol, or ≥ 340,000 g/mol, or ≥ 360,000 g/mol, or ≥ 380,000 g/mol, or ≥ 400,000 g/mol.

S6] The composition of any one of E6]-R6] above, wherein the olefin/alkoxysilane interpolymer has a z average molecular weight (Mz)≤ 500,000 g/mol, or ≤ 480,000 g/mol, or ≤ 460,000 g/mol, or ≤ 440,000 g/mol, or ≤ 420,000 g/mol.

T6] The composition of any one of E6]-S6] above, wherein the composition further comprises a thermoplastic polymer, different from the olefin/silane interpolymer of component a in one or more features, such as monomer(s) types and/or amounts, Mn, Mw, Mz, MWD, or any combination thereof.

U6] A crosslinked composition formed by thermally treating, in the presence of moisture, the composition of any one of E6]-T6] above.

V6] The crosslinked composition of U6] above, wherein the composition is thermally treated at a temperature ≥ 25° C., or ≥ 30° C., or ≥ 35° C., or ≥ 40° C., or ≥ 45° C., or ≥ 50° C., or ≥ 55° C., or ≥ 60° C., or ≥ 65° C., or ≥ 70° C., or ≥ 75° C., or ≥ 80° C.

W6] The crosslinked composition of U6] or V6] above, wherein the composition is thermally treated at a temperature ≤ 100° C., or ≤ 95° C., or ≤ 90° C., or ≤ 85° C.

X6] The crosslinked composition of any one of U6]-W6] above, wherein the composition is thermally treated at a relative humidity (RH) ≥ 5%, or ≥ 10%, or ≥ 15%, or ≥ 20%, or ≥ 25%, or ≥ 30%, or ≥ 35%, or ≥ 40%, or ≥ 45%, or ≥ 50%, or ≥ 55%, or ≥ 60%, or ≥ 65%, or ≥ 70%, or ≥ 75%, or ≥ 80%. Further thermally treated in air.

Y6] The crosslinked composition of any one of U6]-X6] above, wherein the composition is thermally treated at a relative humidity (RH) ≤ 100%, or ≤ 98%, or ≤ 96%, or ≤ 94%, or ≤ 92%, or ≤ 90%, or 88%, or ≤ 86%, or ≤ 85%, or ≤ 84%, or ≤ 83%, or 82%. Further thermally treated in air.

Z6] An article comprising at least one component formed from the composition of any one of E6]-Y6] above.

### TEST METHODS

### 1H NMR Characterization of Interpolymers

For the 1H NMR experiments, each polymer sample was dissolved, in an 8 mm NMR tube, in tetrachloroethane-d2 (with or without 0.001 M Cr(acac)₃). The concentration was approximately 100 mg/1.8 mL. The tube was then heated in a heating block set at 110° C. The sample tube was repeatedly vortexed and heated to achieve a homogeneous flowing fluid. The 1H NMR spectra were taken on a BRUKER AVANCE 500 MHz spectrometer, equipped with a 10 mm C/H DUAL cryoprobe. A standard single pulse 1H NMR experiment was performed. The following acquisition parameters were used: 70 seconds relaxation delay, 90 degree pulse of 17.2 µs, 32 scans. The spectra were centered at “1.3 ppm” with a spectral width of 20 ppm. All measurements were taken without sample spinning at 110° C. The 1H NMR spectra were referenced to a “5.99 ppm” for the resonance peak of solvent (residual protonated tetrachloroethane). For each sample with Cr, the data was taken with 16 second relaxation delay and 128 scans. The “mol% silane” was calculated based on the integration of SiMe proton resonances, versus the integration of CH2 protons associated with ethylene units, and CH3 protons associated with octene units. The “mol% octene (or other alpha-olefin)” was similarly calculated with reference to the CH3 protons associated with octene (or other alpha-olefin). 1H NMR was also used for Study 2 - monitor the conversion of “-Si-H″ to “-Si-OR.”

### 13C NMR Characterization of Interpolymers

For the 13C NMR experiments, each polymer sample was dissolved, in a 10 mm NMR tube, in tetrachloroethane-d2 (with or w/o 0.025 M Cr(acac)₃). The concentration was approximately 300 mg/2.8 mL. The tube was then heated in a heating block set at 110° C. The sample tube was repeatedly vortexed and heated to achieve a homogeneous flowing fluid. The 13C NMR spectra were taken on a BRUKER AVANCE 600 MHz spectrometer, equipped with a 10 mm C/H DUAL cryoprobe. The following acquisition parameters were used: 60 seconds relaxation delay, 90 degree pulse of 12.0 µs, 256 scans. The spectra were centered at “100 ppm” with a spectral width of 250 ppm. All measurements were taken without sample spinning at 110° C. The 13C NMR spectra were referenced to a “74.5 ppm” for the resonance peak of solvent. For the sample with Cr, the data was taken with 7 second relaxation delay and 1024 scans. The “mol% silane” was calculated based on the integration of SiMe carbon resonances, versus the integration of CH2 carbons associated with ethylene units, and CH/CH3 carbons associated with octene units. The “mol% octene (or other alpha-olefin)” was similarly calculated with reference to the CH/CH3 carbons associated with octene (or other alpha-olefin).

### Gel Permeation Chromatography

The chromatographic system consisted of a PolymerChar GPC-IR (Valencia, Spain) high temperature GPC chromatograph, equipped with an internal IR5 infra-red detector (IR5). The autosampler oven compartment was set at 160° C., and the column compartment was set at 150° C. The columns were four AGILENT “Mixed A” 30 cm, 20-micron linear mixed-bed columns. The chromatographic solvent was 1,2,4-trichlorobenzene, which contained 200 ppm of butylated hydroxytoluene (BHT). The solvent source was nitrogen sparged. The injection volume was 200 microliters, and the flow rate was 1.0 milliliters/minute.

Calibration of the GPC column set was performed with 21 narrow molecular weight distribution polystyrene standards, with molecular weights ranging from 580 to 8,400,000, and which were arranged in six “cocktail” mixtures, with at least a decade of separation between individual molecular weights. The standards were purchased from Agilent Technologies. The polystyrene standards were prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards were dissolved at 80° C., with gentle agitation, for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{p o l y e t h y l e n e} = A \times {\left({M}_{p o l y s t y r e n e}\right)}^{B} \qquad \text{(EQ1)}$$

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects, such that linear homopolymer polyethylene standard was obtained at 120,000 Mw.

The total plate count of the GPC column set was performed with decane (prepared at “0.04 g in 50 milliliters” of TCB, and dissolved for 20 minutes with gentle agitation.) The plate count (Equation 2) and symmetry (Equation 3) were measured on a 200 microliter injection according to the following equations:

$$P l a t e C o u n t = 5.54 ∗ {\left(\frac{\left({\text{RV}}_{\text{Peak Max}}\right)}{P e a k W i d t h a t \frac{1}{2} h e i g h t}\right)}^{2} \qquad \text{(EQ2)}$$

where RV is the retention volume in milliliters, the peak width is in milliliters, the peak max is the maximum height of the peak, and ½ height is ½ height of the peak maximum; and

$$S y m m e t r y = \frac{\left(R e a r P e a k R {V}_{o n e t e n t h h e i g h t} - R {V}_{P e a k m a x}\right)}{\left(R {V}_{P e a k m a x} - F r o n t P e a k R {V}_{o n e t e n t h h e i g h t}\right)} \qquad \text{(EQ3)}$$

where RV is the retention volume in milliliters, and the peak width is in milliliters, Peak max is the maximum position of the peak, one tenth height is ⅒ height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples were prepared in a semi-automatic manner with the PolymerChar “Instrument Control” Software, wherein the samples were weight-targeted at “2 mg/ml,” and the solvent (contained 200 ppm BHT) was added to a pre nitrogen-sparged, septa-capped vial, via the PolymerChar high temperature autosampler. The samples were dissolved for two hours at 160° C. under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$$M {n}_{\left(G P C\right)} = \frac{{\sum }_{}^{i} I {R}_{i}}{{\sum }_{}^{i} \left(\frac{I {R}_{i}}{{M}_{p o l y e t h y l e n {e}_{i}}}\right)} \qquad \text{(EQ 4)}$$

$$M {w}_{\left(G P C\right)} = \frac{{\sum }_{}^{i} \left(I {R}_{i} ∗ {M}_{p o l y e t h y l e n {e}_{i}}\right)}{{\sum }_{}^{i} I {R}_{i}} \qquad \text{(EQ 5)}$$

and

$$M {z}_{\left(G P C\right)} = \frac{{\sum }_{}^{i} \left(I {R}_{i} ∗ {M}_{p o l y e t h y l e n {e}_{i}} {}^{2}\right)}{{\sum }_{}^{i} \left(I {R}_{i} ∗ {M}_{p o l y e t h y l e n {e}_{i}}\right)} \qquad \text{(EQ 6)}$$

In order to monitor the deviations over time, a flowrate marker (decane) was introduced into each sample, via a micropump controlled with the PolymerChar GPC-IR system. This flowrate marker (FM) was used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak were then assumed to be related to a linear-shift in flowrate (Flowrate(effective)) for the entire run. To facilitate the highest accuracy of a RV measurement of the flow marker peak, a least-squares fitting routine was used to fit the peak of the flow marker concentration chromatogram to a quadratic equation. The first derivative of the quadratic equation was then used to solve for the true peak position. After calibrating the system, based on a flow marker peak, the effective flowrate (with respect to the narrow standards calibration) was calculated from Equation 7: Flowrate(effective) = Flowrate(nominal) * (RV(FM Calibrated) / RV(FM Sample)) (EQ7). Processing of the flow marker peak was done via the PolymerChar GPCOne™ Software. Acceptable flowrate correction is such that the effective flowrate should be within +/-0.7% of the nominal flowrate.

### Dynamic Mechanical Analysis (DMA)

The rheological properties of a molded disk was characterized by Dynamic Mechanical Analysis (DMA), as a function of temperature, using an ARES-G2 Rheometer, fitted with 25 mm parallel plates (disposable aluminum), and operated in oscillatory shear mode, at a frequency of 1 rad/sec and strain amplitude < 0.1%. After loading the sample disk, a pre-load of 100 g force was used to ensure good contact with the plates. At the start of the run, the environment was equilibrated at 25° C. A temperature ramp was initiated, and the sample was heated from 25° C. to 200° C., at 2.0° C./min, using heated N2 gas, while the complex viscosity or shear storage modulus was measured.

### Gel Content - Soxhlet Extraction

Each Soxhlet extraction was performed according to ASTM D2765-16. Method A.

### EXPERIMENTAL

### Synthesis of Terpolymer 1, Terpolymer 2, and Copolymer 1

The ethylene/octene/silane co-polymerizations were conducted in an autoclave batch reactor designed for ethylene homo-polymerizations and co-polymerizations. The reactor was equipped with electrical heating bands, and an internal cooling coil containing chilled glycol. Both the reactor and the heating/cooling system were controlled and monitored by a process computer. The bottom of the reactor was fitted with a dump valve, which emptied the reactor contents into a dump pot that was vented to the atmosphere.

All chemicals used for polymerization and the catalyst solutions were run through purification columns prior to use. The ISOPAR-E, 1-octene, ethylene, and the silane monomers were also passed through columns. Ultra-high purity grade nitrogen (Airgas) and hydrogen (Airgas) were used. The catalyst cocktail was prepared by mixing, in an inert glove box, the scavenger (MMAO), activator (bis(hydrogenated tallow alkyl)methyl tetrakis(pentafluoro-phenyl)borate(1<->) amine), and catalyst with the appropriate amount of toluene, to achieve a desired molarity solution. The solution was then diluted with ISOPAR-E or toluene to achieve the desired quantity for the polymerization, and drawn into a syringe for transfer to a catalyst shot tank.

In a typical polymerization, the reactor was loaded with ISOPAR-E, and 1-octene (if desired) via independent flow meters. The silane monomer was then added via a shot tank piped in through an adjacent glove box. After the solvent/comonomer addition, hydrogen (if desired) was added, while the reactor was heated to a polymerization setpoint of 120° C. The ethylene was then added to the reactor via a flow meter, at the desired reaction temperature, to maintain a predetermined reaction pressure set point. The catalyst solution was transferred into the shot tank, via syringe, and then added to the reactor via a high pressure nitrogen stream, after the reactor pressure set point was achieved. A run timer was started upon catalyst injection, after which, an exotherm was observed, as well as a decrease in the reactor pressure, to indicate a successful run.

Ethylene was then added using a pressure controller to maintain the reaction pressure set point in the reactor. The polymerizations were run for a set time or ethylene uptake, after which, the agitator was stopped, and the bottom dump valve was opened to empty the reactor contents into dump pot. The pot contents were poured into trays, which were placed in a fume hood, and the solvent was allowed to evaporate overnight. The trays containing the remaining polymer were then transferred to a vacuum oven, and heated to 100° C., under reduced pressure, to remove any residual solvent. After cooling to ambient temperature, the polymers were weighed for yield/efficiencies, transferred to containers for storage, and submitted for analytical testing. Polymerization conditions and catalysts are shown in Tables 1A and 1B, respectively. Polymer properties are shown in Table 2.

TABLE 1A

Polymerization Conditions to produce SiH—POE

| Polymer | Catalyst | Reactor Size | Reactor Pressure (psi) | Ethylene loaded (g) | Octene loaded (g) | Silane monomer loaded (g) | Solvent loaded (g) | H₂ loaded (mmol) | Run Time (min) |
|---|---|---|---|---|---|---|---|---|---|
| Terpolymer 1 | PE CAT 1 | 1 gal | 107.1 | 20.3 | 19.8 | 4.6 | 1145.9 | 20.1 | 10.0 |
| Terpolymer 2 | PE CAT 1 | 2 L | 122.6 | 12.1 | 53.0 | 22.6 | 566.3 | 4.3 | 8.65 |
| Copolymer 1 | PE CAT 2 | 2 L | 113.6 | 11.1 | 0 | 6.1 | 601.4 | 0 | 10.15 |

TABLE 1B

Catalysts

| | |
|---|---|
| CAT 1 (WO2007/136496) | CAT 2 (WO1995/000526) |
| 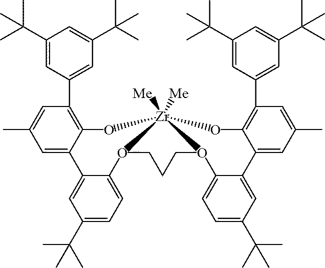 | 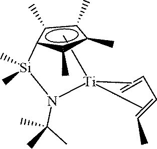 |

TABLE 2

Polymer Properties

| Polymer | Conventional GPC Summary | | | Polymer Composition | | |
|---|---|---|---|---|---|---|
| | Mn (kg/mol) | Mw (kg/mol) | Mw/Mn | Silane Type | Silane mol%^{∗} | Octene mol%^{∗} |
| Terpolymer 1 | 29.0 | 100.5 | 3.5 | ODMS^{A} | 0.66 | 4.87 |
| Terpolymer 2 | 62.3 | 146.9 | 2.4 | HDMS^{B} | 4.75 | 18.28 |
| Copolymer 1 | 74.6 | 177.9 | 2.4 | ODMS^{A} | 1.9 | 0 |

^{∗}Mol% silane and octene based on total moles of monomers in polymer, and determined by ¹³C (for Terpolymer 1) or ¹H NMR (for Terpolymer 2 and Copolymer 1).
A: ODMS = 7-Octenyldimethylsilane.
B: HDMS = 5-Hexenyldimethylsilane.

### Study 1 - Moisture Cure of Olefin/Silane Interpolymer

### Commercial Materials

The following compounds were examined as cure catalysts.

Dibutyltindilaurate 95%, available from Sigma-Aldrich.

Tetrabutyl titanium oxide, available from Sigma-Aldrich.

1,8-Diazabicyclo[5.4.0]undec-7-ene (DBU), available from Sigma Aldrich.

Dodecylbenezene sulfonic acid (DBSA), available from Sigma Aldrich.

Bismuth trifluorosulfonic acid, available from Sigma Aldrich.

Tris(pentafluorophenyl)borane (FAB), available from Sigma Aldrich.

### Moisture Cure

Terpolymer 1 or Terpolymer 2 was added to a HAAKE dispersive mixer set to 85° C. The polymer was allowed to mix, until the measured mixer torque was unchanging - usually about two minutes. An amount of the cure catalyst was added to the mixing polymer, to make, for example, a “1000 ppm addition” of the cure catalyst by weight of the terpolymer. Mixing of the catalyst into the terpolymer continued for five minutes, and the resulting mixture was then quickly removed from the mixer. During the mixing of the catalyst and terpolymer, no change in torque was noted. The cooled polymer formulation was subsequently molded into DMA disks (25 mm diameter x 2 mm thick). These disks were compression molded using a Carver Press (20,000 lbs of force, 80° C., 4 minutes), and then cooled immediately between water-cooled platens for two minutes.

Each composition (disk) was measured for its temperature dependent rheological properties, with and without exposure to moisture. Those sample disks exposed to moisture were placed into a Blue M SPX programmable environmental chamber, set at 85° C. and 85% relative humidity for 5-7 days. It is noted that the composition readily equilibrates (less than 30 minutes) to the set temperature of the environmental chamber. Control compositions (disks) that did not contain a cure catalyst were also examined. DMA was performed using an ARES-G2 Rheometrics analyzer, at a temperature from 25° C. to 200° C., and a rate of 2.0° C./min. Each sample disk was tested in a parallel plate geometry, using “25 mm diameter” plates.

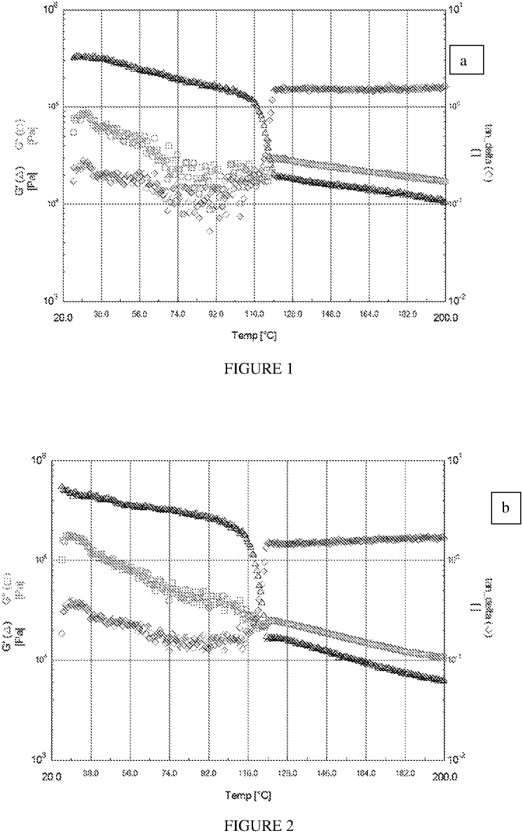

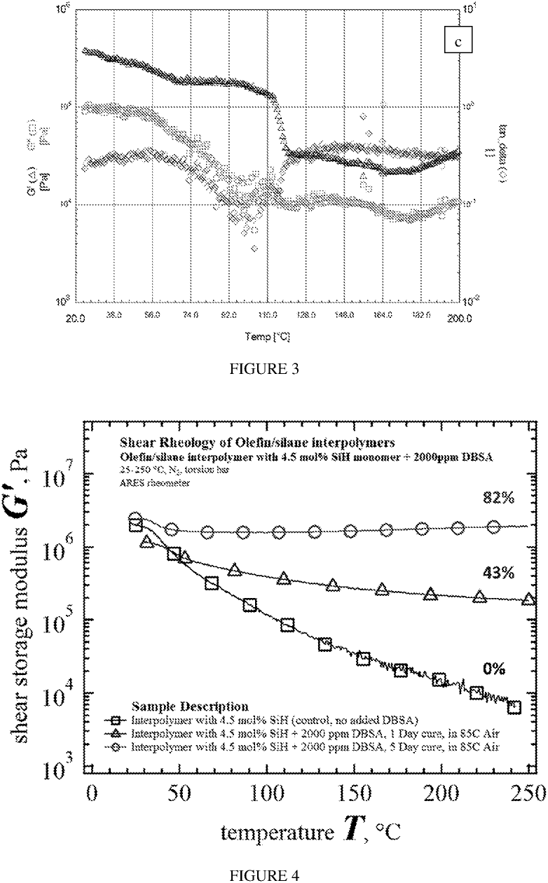

FIGS. 1-3 show DMA profiles for the formulation containing dibutyltindilaurate. FIG. 1 represents a control composition (Terpolymer 1). FIG. 2 represents a composition (Terpolymer 1 and dibutyltindilaurate) that was not subject to moisture cure, only subject to above compression molding. FIG. 3 represents a composition (Terpolymer 1 and dibutyltindilaurate) that was subject to moisture cure at 85 C/85% RH for 6 days. As seen in FIG. 1, the DMA data show that the terpolymer without the cure catalyst (control) has a normal temperature dependent rheology, exhibiting melting behavior around 105° C., and decreasing melt viscosity with increasing temperature. FIG. 2 shows that the presence of the dibutyltin dilaurate in the composition (no moisture cure) does not significantly alter the polymer rheology. FIG. 3 shows that after moisture curing for 6 days, the polymer exhibits significant crosslinked rubber rheology above the melting point, possessing both a nearly flat storage modulus with temperature and a nearly flat tan-delta function.

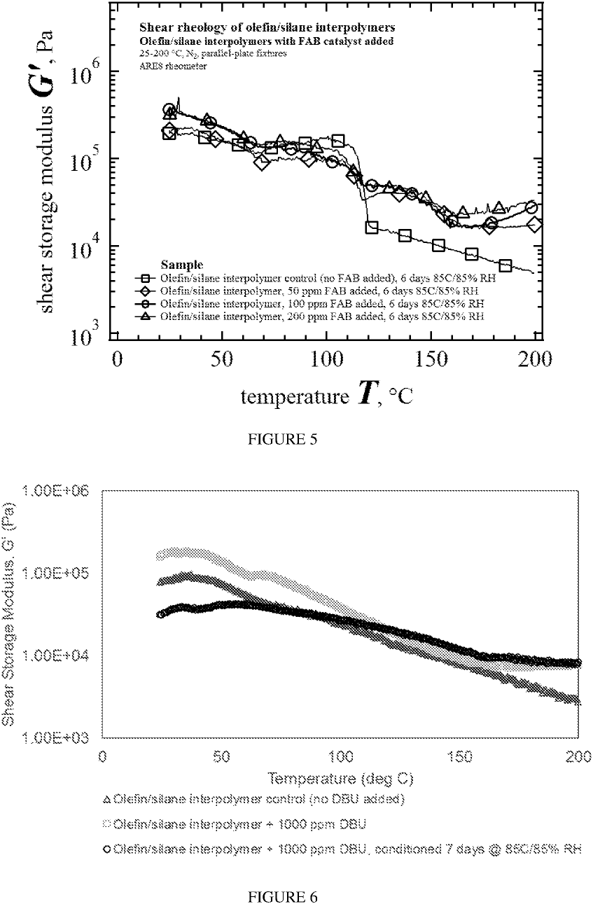

See also FIGS. 4-6. FIG. 4 (Terpolymer 2) shows DMA profiles for the formulations with or without DBSA; those with DBSA (2000 ppm) were subject to air cure at 85° C., for 1 day or 5 days. FIG. 5 (Terpolymer 1) shows DMA profiles for the formulations with FAB (50, 100 and 200 ppm) or without FAB, and subject to moisture cure at 85 C/85%RH for 6 days. FIG. 6 (Terpolymer 1) shows DMA profiles for the formulations with DBU (1000 ppm) or without DBU; those with DBU were not subject to moisture cure, or subject to moisture cure at 85 C/85%RH for 7 days.

Table 3 lists some cure results for this study. As seen in Table 3, optimum cure was observed for the inventive compositions 1, 2, and 4.

TABLE 3

Cure at 85C/85% RH^{∗} for 5-7 Days

| Ex. | Cure Catalyst | Terpolymer | Moisture Cure | Gel content (wt%) |
|---|---|---|---|---|
| Inv. 1 | Dibutyltindilaurate | Terpolymer 1 | yes | 78 |
| Comp. A | DBU | Terpolymer 1 | no | 0 |
| Inv. 2^{∗∗} | DBSA | Terpolymer 2 | yes | 82 |
| Inv. 3 | Bismuth trifluorosulfonic acid | Terpolymer 1 | slight | 37 |
| Inv. 4 | FAB | Terpolymer 1 | yes | 83 |

^{∗}RH = Relative Humidity, and is the ratio of the partial pressure of water vapor to the equilibrium vapor pressure of water at a given temperature. Here the RH is set and monitored by the environmental chamber of the Blue M SPX programmable oven (with a built-in hygrometer), as discussed above.
^{∗∗}Cured in air at 85° C.

### Study 2 - Functionalization of Olefin/Silane Interpolymer

### Conversion of Si—H to Si—OMe (Ethylene/Alkoxysilane Copolymer 1A)

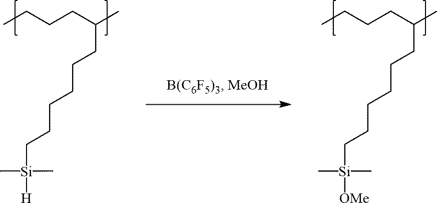

To a 40 mL of glass bottle, containing a magnetic stir bar, was added Copolymer 1 (191 mg) and anhydrous toluene (5 mL) under N₂. The bottle was placed onto a pre-heated hot plate (100° C.) to fully dissolve the polymer. Then B(C₆F₅)₃ (0.25 mg, dissolved in 0.25 mL toluene) was added to the bottle, followed by a slow addition of 1.7 mL of methanol/toluene solution (1:5 methanol/toluene, v/v, dried over molecular sieves). After the addition, the mixture was stirred at 100° C. for two hours, then cooled to room temperature and filtered. Product (Ethylene/Alkoxysilane Copolymer 1A): white solid, 190 mg, and ¹H NMR (tetrachloroethane-d₂, 500 MHz): 3.48 (singlet, 3H, Si—OCH₃), 1.60-1.15 (broad peak, 235H), 0.69 (triplet, J = 7.5 Hz, 2H, —CH₂—Si), 0.17 (s, 6H, —Si(CH₃)₂).

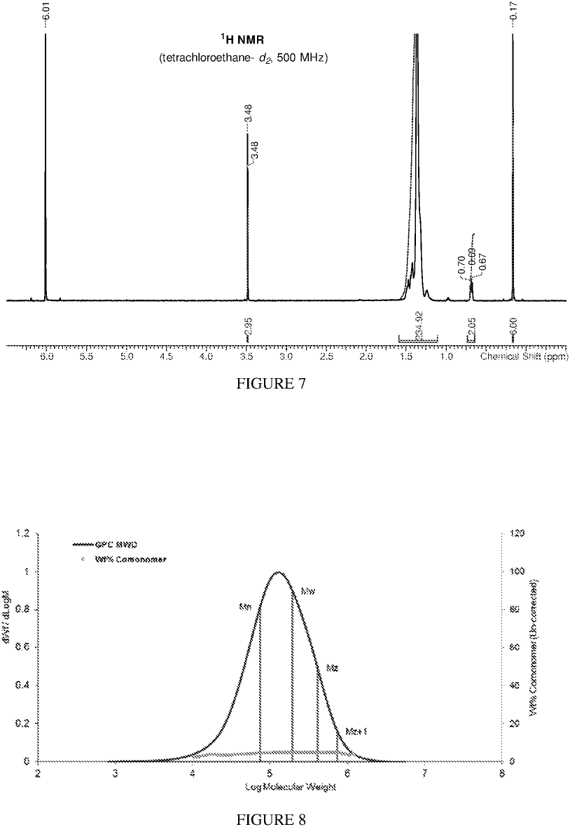

Analysis was performed by ¹H NMR (tetrachloroethane-d₂, 110° C.). The Si—H groups were completely consumed as evidenced by the absence of a resonance at 3.95 ppm. The emergence of peak at 3.48 ppm (singlet) corresponded to the —SiMe2—O—CH3 of the product. See FIG. 7.

### Conversion of Si—H to Si—OEt (Ethylene/Alkoxysilane Copolymer 1B)

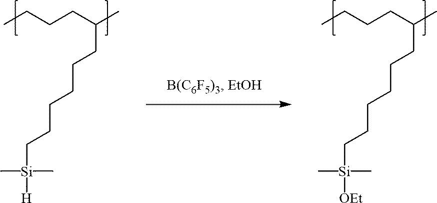

To a 100 mL of glass bottle, containing a magnetic stir bar, was added Copolymer 1 (2.4 g) and anhydrous toluene (50 mL) under N₂. The bottle was placed onto a pre-heated hotplate (100° C.) to fully dissolve the polymer. Then B(C₆F₅)₃ (2.4 mg, dissolved in 2.4 mL toluene) was added to the bottle, followed by a slow addition of 7.0 mL of ethanol/toluene solution (1:1 ethanol/toluene, v/v, dried over molecular sieves). After the addition, the mixture was stirred at 100° C. for two hours, then cooled to room temperature and filtered. Product (Ethylene/Alkoxysilane Copolymer 1B): white solid, 2.5 g, and ¹H NMR (tetrachloroethane-d₂, 500 MHz): 3.74 (quartet, J = 7.5 Hz, 2H, Si—OCH₂—), 1.60-1.15 (broad peak, 228H, overlapped with peak at 1.23 ppm (triplet, J = 7.5 Hz, —CH₃)), 0.68 (triplet, J = 7.5 Hz, 2H, —CH₂—Si), 0.16 (s, 6H, —Si(CH₃)₂).

Analysis was performed by ¹H NMR (tetrachloroethane-d₂, 110° C.). The Si—H groups were completely consumed as evidenced by the absence of a resonance at 3.95 ppm. The emergence of peak at 3.74 ppm (quartet) and 1.23 ppm (triplet) corresponded to the —SiMe2—O—CH2CH3 of the product. GPC results are shown in Table 4. See also FIG. 8.

TABLE 4

GPC Results for Copolymer 1B

| | |
|---|---|
| Mn | 74,710 |
| Mp (peak MW) | 128,470 |
| Mv | 175,510 |
| Mw | 195,350 |
| Mz | 411,410 |
| PDI (MWD) | 2.61 |

### Conversion of Si—H to Si—OiPr (Ethylene/Alkoxysilane Copolymer 1C)

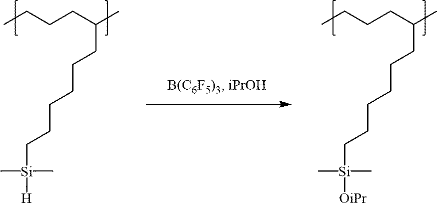

To a 40 mL of glass vial, containing a magnetic stir bar, was added Copolymer 1 (230 mg) and anhydrous toluene (5 mL) under N₂. The bottle was placed onto a pre-heated hotplate (100° C.) to fully dissolve the polymer. Then B(C₆F₅)₃ (0.3 mg, dissolved in 0.3 mL toluene) was added to the bottle, followed by a slow addition of 2.5 mL of isopropanol/toluene solution (1:5 isopropanol/toluene, v/v, dried over molecular sieves). After the addition, the mixture was stirred at 100° C. for two hours, then cooled to room temperature, and filtered. Product (Ethylene/Alkoxysilane Copolymer 1C): white powder, 235 mg, and ¹H NMR (tetrachloroethane-d₂, 500 MHz): 4.07 (multiplet, 1H, Si—OCH—), 1.60-1.23 (broad peak, 220H), 1.22 (doublet, J = 5.0 Hz, 6H, —O—CH(CH₃)₂), 0.66 (triplet, J = 5.0 Hz, 2H, —CH₂—Si), 0.16 (s, 6H, —Si(CH₃)₂).

Analysis was performed by ¹H NMR (tetrachloroethane-d₂, 110° C.). The Si—H groups were completely consumed as evidenced by the absence of a resonance at 3.95 ppm. The emergence of peak at 4.07 ppm (multiplet) and 1.22 ppm (doublet) corresponded to the —SiMe2—O—CH(CH3)2 of the product. GPC results are shown in Table 5.

TABLE 5

GPC Results for Copolymer 1C

| | |
|---|---|
| Mn | 75,780 |
| Mp | 134,580 |
| Mv | 174,820 |
| Mw | 194,220 |
| Mz | 408,840 |
| PDI (MWD) | 2.56 |

The inventive ethylene/alkoxysilane copolymers should be easily processed on conventional thermoplastic equipment to form an end product, which can be cured off-line, for example, by exposure to moisture in the presence of a condensation catalyst.

What is claimed is:

1. A process to form a crosslinked composition, said process comprising thermally treating a composition at a temperature ≥ 25° C., in the presence of moisture, and wherein the composition comprises the following components:
a) an olefin/silane interpolymer,
b) a cure catalyst selected from the following compounds i)-vi):
i) a metal alkoxide,
ii) a metal carboxylate,
iii) a metal sulfonate,
iv) an aryl sulfonic acid,
v) a tris-aryl borane,
vi) any combination of two or more from i)-v).

2. The process of claim 1, wherein the thermal treatment takes place at ≥ 5% RH (Relative Humidity).

3. The process of claim 1, wherein the moisture comprises moisture originating from adsorbed and/or absorbed water on the cure catalyst.

4. The process of claim 1, wherein the cure catalyst of component b) is selected from the following compounds i), ii), or iv)-vi).

5. The process of claim 1, wherein the silane of the olefin/silane interpolymer is derived from a monomer selected from the following: H₂C═CH—R1—Si(R)(R′)—H, where R1 is an alkylene, and R and R′ are each independently an alkyl, and R and R′ may be the same or different.

6. A composition comprising the following components:
a) an olefin/silane interpolymer,
b) a cure catalyst selected from the following compounds i)-vi):
i) a metal alkoxide,
ii) a metal carboxylate,
iii) a metal sulfonate,
iv) an aryl sulfonic acid,
v) a tris-aryl borane,
vi) any combination of two or more from i)-v).

7. The composition of claim 6, wherein the silane of the olefin/silane interpolymer is derived from a monomer selected from the following: H₂C═CH—R1—Si(R)(R′)—H, where R1 is an alkylene, and R and R′ are each independently an alkyl, and R and R′ may be the same or different.

8. A crosslinked composition formed from the composition of claim 6.

9. An article comprising at least one component formed from the composition of claim 6.

10. A process to form an olefin/alkoxysilane interpolymer, said process comprising thermally treating a composition comprising the following components:
a) an olefin/silane interpolymer,
b) an alcohol,
c) a Lewis acid.

11. The process of claim 10, wherein component c is selected from the following i)-vi):
i) B(R¹)(R²)(R³), where each of R¹, R² and R³ is, independently, a substituted or unsubstituted aryl group,
ii) BX₃, where X is a halo group,
iii) AlR₃, where R is a substituted or unsubstituted alkyl group,
iv) AlX₃, where X is a halo group,
v) SiX₄, where X is a halo group,
vi) any combination of two or more from i)-v).

12. The process of claim 10, wherein component b is selected from the following: CₙH₂ₙ₊₁OH, where n ≥ 1.

13. The process of claim 10, wherein the silane of the olefin/silane
interpolymer (component a) is derived from a silane monomer selected from the following: H₂C=CH-R1-Si(R)(R′)-H, where R1 is an alkylene, and R and R′ are each independently an alkyl, and R and R′ may be the same or different.

14. A composition comprising an olefin/alkoxysilane interpolymer formed from the process of claim 10.

15. An article comprising at least one component formed from the composition of claim 14.
